(19) United States
(12) Patent Application Publication
(10) Pub. No.: US 2016/0004803 A1
(43) Pub. Date: Jan. 7, 2016

(54) Simulation Sequence In Chemical Process Simulation For Chemical Process Flowsheet With Strongly Connected Components

(71) Applicant: Chyou and Hsu Family Trust 2013, Oak Park, CA (US)

(72) Inventor: Shang-Woo CHYOU, Oak Park, CA (US)

(21) Appl. No.: 14/793,450

(22) Filed: Jul. 7, 2015

Related U.S. Application Data
(60) Provisional application No. 62/021,562, filed on Jul. 7, 2014.

(51) Int. Cl. G06F 17/50; G06F 17/10

(52) U.S. Cl. CPC G06F 17/5009; G06F 17/10

(57) ABSTRACT

A computer system with multiple processors and memory identifies a plurality of computation units for a chemical process flowsheet represented by a graph with a plurality of components. The plurality of components includes at least one group of strongly connected components. Each computation unit of the plurality of computation units is either a single component or a group of strongly connected components of the plurality of components. The computer system identifies two or more non-overlapping computation units of the plurality of computation units. All chemical inputs to the two or more non-overlapping computation units have been determined. The computer system processes the two or more non-overlapping computation units at least partially in parallel by processing each computation unit of the two or more non-overlapping computation units using a separate set of one or more processors. The computer system determines process flows for the chemical process flowsheet.

### RELATED APPLICATION

This application claims the benefit of and priority to U.S. Provisional Patent Application Ser. No. 62/021,562, filed Jul. 7, 2014, entitled “Simulation Sequence in Chemical Process Simulation for Chemical Process Flowsheet with Strongly Connected Components,” which is incorporated by reference herein in its entirety.

### TECHNICAL FIELD

This application relates generally to determining chemical process flows, and in particular, to computer systems and methods for determining chemical process flows for a chemical process flowsheet.

### BACKGROUND

Industrial chemical processes are used to produce various products, such as foods, cosmetics, pharmaceuticals, and petroleum products.

Process flowsheets (also known as process flow diagrams) are widely used in chemical engineering and process engineering to represent chemical process components and chemical flows among chemical process components. Process flowsheets are used to determine chemical process parameters through simulation. However, chemical process flowsheets can be complex for industrial processes, and it takes a long time to determine chemical process parameters for such chemical process flowsheets.

### SUMMARY

Thus, there is a need for more efficient methods and systems for determining chemical processes for chemical process flowsheets.

A number of embodiments (e.g., computer systems, and methods of operating such systems) that overcome the limitations and disadvantages described above are presented in more detail below.

In accordance with some embodiments, a method is performed at a computer system with multiple processors and memory. The method includes identifying a plurality of computation units for a chemical process flowsheet represented by a graph with a plurality of components. The plurality of components includes at least one group of strongly connected components. Each computation unit of the plurality of computation units is either a single component or a group of strongly connected components of the plurality of components. The method also includes identifying two or more non-overlapping computation units of the plurality of computation units. All chemical inputs to the two or more non-overlapping computation units have been determined. The method further includes processing the two or more non-overlapping computation units at least partially in parallel by processing each computation unit of the two or more non-overlapping computation units using a separate set of one or more processors, and determining process flows for the chemical process flowsheet.

In accordance with some embodiments, a computer system includes multiple processors, and memory storing one or more programs for execution by the multiple processors. The one or more programs including instructions for identifying a plurality of computation units for a chemical process flowsheet represented by a graph with a plurality of components. The plurality of components includes at least one group of strongly connected components. Each computation unit of the plurality of computation units is either a single component or a group of strongly connected components of the plurality of components. The one or more programs include instructions for identifying two or more non-overlapping computation units of the plurality of computation units. All chemical inputs to the two or more non-overlapping computation units have been determined. The one or more programs include instructions for processing the two or more non-overlapping computation units at least partially in parallel by processing each computation unit of the two or more non-overlapping computation units using a separate set of one or more processors. The one or more programs include instructions for determining process flows for the chemical process flowsheet.

In accordance with some embodiments, a non-transitory computer readable storage medium stores one or more programs for execution by multiple processors of a computer system. The one or more programs include instructions for identifying a plurality of computation units for a chemical process flowsheet represented by a graph with a plurality of components. The plurality of components includes at least one group of strongly connected components. Each computation unit of the plurality of computation units is either a single component or a group of strongly connected components of the plurality of components. The one or more programs include instructions for identifying two or more non-overlapping computation units of the plurality of computation units. All chemical inputs to the two or more non-overlapping computation units have been determined. The one or more programs include instructions for processing the two or more non-overlapping computation units at least partially in parallel by processing each computation unit of the two or more non-overlapping computation units using a separate set of one or more processors. The one or more programs include instructions for determining process flows for the chemical process flowsheet.

### BRIEF DESCRIPTION OF THE DRAWINGS

For a better understanding of the disclosed embodiments, reference should be made to the Description of Embodiments below, in conjunction with the following drawings in which like reference numerals refer to corresponding parts throughout the figures.

FIG. 1 illustrates an exemplary chemical process flowsheet in accordance with some embodiments.

FIG. 2 is a block diagram illustrating a distributed computer system in accordance with some embodiments.

FIG. 3 is a block diagram illustrating a grid server in accordance with some embodiments.

FIG. 4 is a block diagram illustrating a node system in accordance with some embodiments.

FIG. 5 is a block diagram illustrating a client system in accordance with some embodiments.

FIGS. 6A-6Q illustrate determining chemical flows for a chemical process flowsheet in accordance with some embodiments.

FIG. 7 is a flowchart illustrating operations performed by a distributed computing system in accordance with some embodiments.

FIGS. 8A-8C are flowcharts illustrating a method of determining chemical process flows for a chemical process flowsheet in accordance with some embodiments.

### DESCRIPTION OF EMBODIMENTS

The computer systems and methods described herein enable more efficient and faster determination of chemical process flows for a chemical process flowsheet.

As used herein, determining a chemical process flow of a chemical process (or a corresponding node), simulating the chemical process flow of the chemical process, and processing the chemical process (or the corresponding node) are used interchangeably.

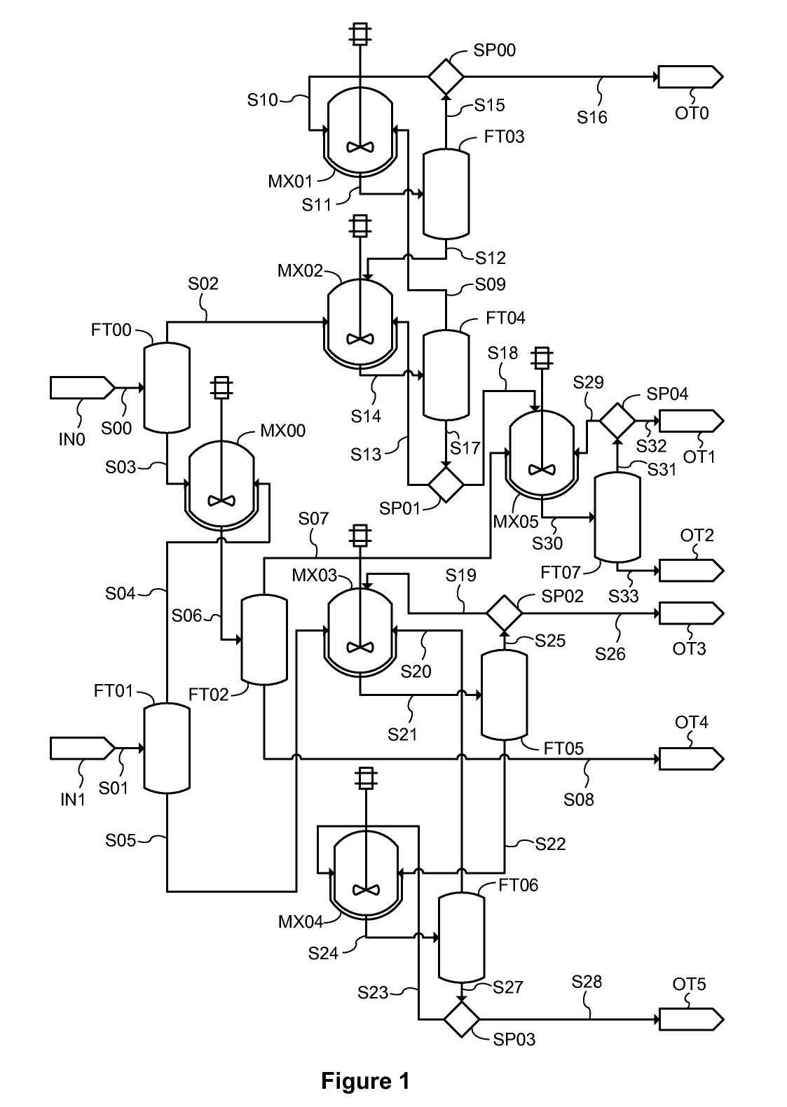

FIG. 1 illustrates an exemplary chemical process flowsheet in accordance with some embodiments.

In FIG. 1, a plurality of chemical process components and chemical flows are shown. For example, IN0 and IN1 represent input flows, and OT0, OT1, OT2, OT3, OT4, and OT5 represent output flows. FT00, FT01, FT02, FT03, FT04, FT05, FT06, and FT07 represent vessels (e.g., two-outlet flash drums). MX00, MX01, MX02, MX03, MX04, and MX05 represent mixers (e.g., jacketed mixing vessels). SP00, SP01, SP02, SP03, and SP04 are split valves. S00 through S33 represent chemical flows between chemical process components (e.g., vessels, reactors, and split valves). For example, S00 represents a chemical flow from IN0 to FT00. S01 represents a chemical flow from IN1 to FT01. S02 represents a chemical flow from FT00 to MX02. S03 represents a chemical flow from FT00 to MX00. S04 represents a chemical flow from FT01 to MX00. S05 represents a chemical flow from FT01 to MX03. S06 represents a chemical flow from MX00 to FT02. S07 represents a chemical flow from FT02 to MX05. S08 represents a chemical flow from FT02 to OT4. S09 represents a chemical flow from FT04 to MX01. S10 represents a chemical flow from SP00 to MX01. S11 represents a chemical flow from MX01 to FT03. S12 represents a chemical flow from FT03 to MX02. S13 represents a chemical flow from SP01 to MX02. S14 represents a chemical flow from MX02 to FT04. S15 represents a chemical flow from FT03 to SP00. S16 represents a chemical flow from SP00 to OT0. S17 represents a chemical flow from FT04 to SP01. S18 represents a chemical flow from SP01 to MX05. S19 represents a chemical flow from SP02 to MX03. S20 represents a chemical flow from FT06 to MX03. S21 represents a chemical flow from MX03 to FT05. S22 represents a chemical flow from FT05 to MX04. S23 represents a chemical flow from SP03 to MX04. S24 represents a chemical flow from MX04 to FT06. S25 represents a chemical flow from FT05 to SP02. S26 represents a chemical flow from SP02 to OT3. S27 represents a chemical flow from FT06 to SP03. S28 represents a chemical flow from SP03 to OT5. S29 represents a chemical flow from SP04 to MX05. S30 represents a chemical flow from MX05 to FT07. S31 represents a chemical flow from FT07 to SP04. S32 represents a chemical flow from SP04 to OT1. S33 represents a chemical flow from FT07 to OT2.

Each chemical process component is associated with a model. Typically, the model needs to satisfy the law of conservation of mass, the laws of thermodynamics, and the laws of chemical reaction kinetics. For example, a vessel (e.g., FT00) with one input flow (e.g., S00) and two output flows (e.g., S02 and S03) needs to satisfy that a flow rate of the one input flow matches a sum of flow rates of the two output flows (e.g., F_{S00}=F_{S02}+F_{S03}, where F_{S00} represents a flow rate of S00, F_{S02} represents a flow rate of S02, and F_{S03} represents a flow rate of S03). In some embodiments, a ratio of the two output flows of the vessel matches a value that is determined based on an operating condition (e.g., temperature and pressure) of FT00 and a condition (e.g., temperature and pressure) of S00 (e.g., F_{S02}/F_{S03} is 1 at 20° C., indicating that the flow rate of S02 and the flow rate of S03 are equal at 20° C.). Flow rates of a chemical compound at a chemical process component (e.g., inflows and outflows) should satisfy the law of mass conservation. Chemical compounds in a chemical process component should obey the laws of chemical thermodynamics. In another example, a mixer (e.g., MX00) with multiple input flows (e.g., S03 and S04) and one output flow (e.g., S06) needs to satisfy that a sum of flow rates of the multiple input flows matches a flow rate of the one output flow. In addition, various parameters, such as temperatures of the multiple input flows, concentrations of chemical species in the multiple input flows, flow rates of the multiple input flows, a residence time of chemicals in the mixer, a total volume of chemicals in the mixer, a temperature inside the mixer, and heat transfer coefficients, are used to simulate the one output flow (e.g., a temperature, a pressure, a flow rate, concentrations of chemical species in the one output flow, etc.).

Chemical process flowsheets are frequently used in process simulations. Process simulations use mathematical models of chemical and physical processes to determine chemical process flows (e.g., outputs of the chemical and physical processes). For example, a reactor is typically modeled using one or more differential equations, and simulating a chemical process for the reactor includes obtaining solutions for the one or more differential equations. A chemical process flowsheet with multiple chemical processes presents a large number of equations that need to be solved. However, a first chemical process that receives an output from a second chemical process typically requires, for simulation of the first chemical process, that the output of the second chemical process is determined. Thus, the first chemical process and the second chemical process need to be simulated sequentially. However, sequentially simulating all of the chemical processes one-by-one is time consuming and inefficient.

Developments in parallel processing technologies (e.g., a multi-core processor, a multiple-processor computer system, clustered computing, and/or distributed computing) provide the potential for faster simulations. However, for a chemical process flowsheet that includes dependent chemical processes (i.e., chemical processes that receive, as inputs, outputs from other chemical processes), it is necessary to identify which chemical processes can be simulated simultaneously to utilize parallel processing. The methods described herein address the problem with various solutions, including using identification of strongly connected components.

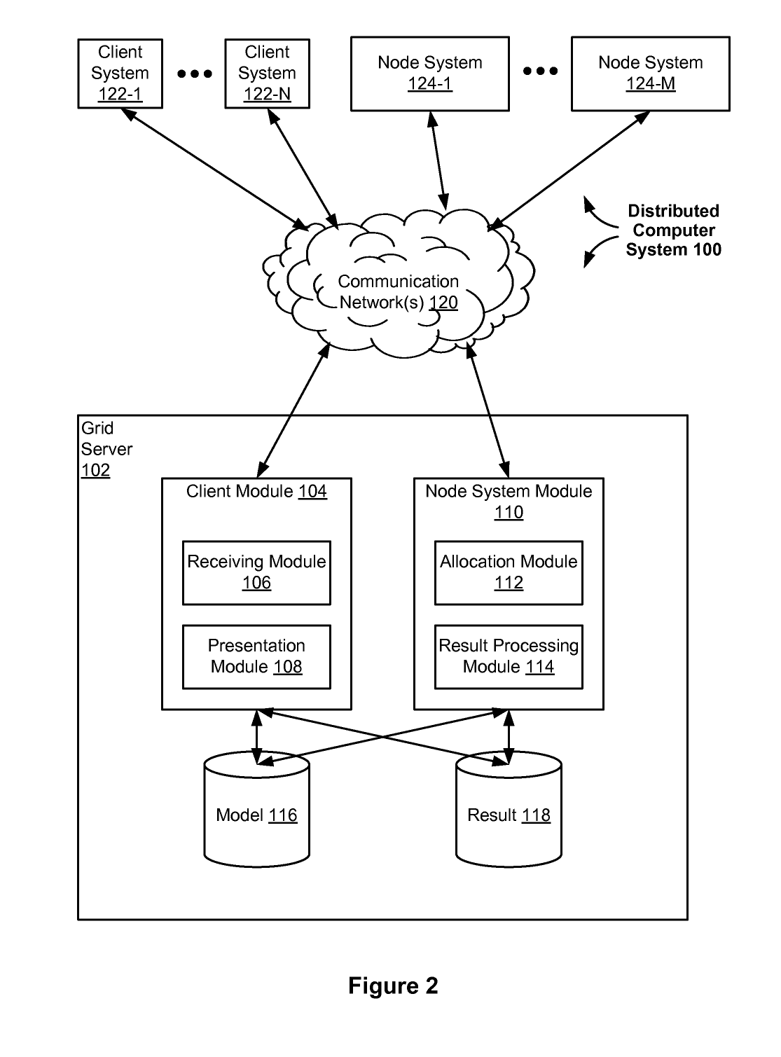

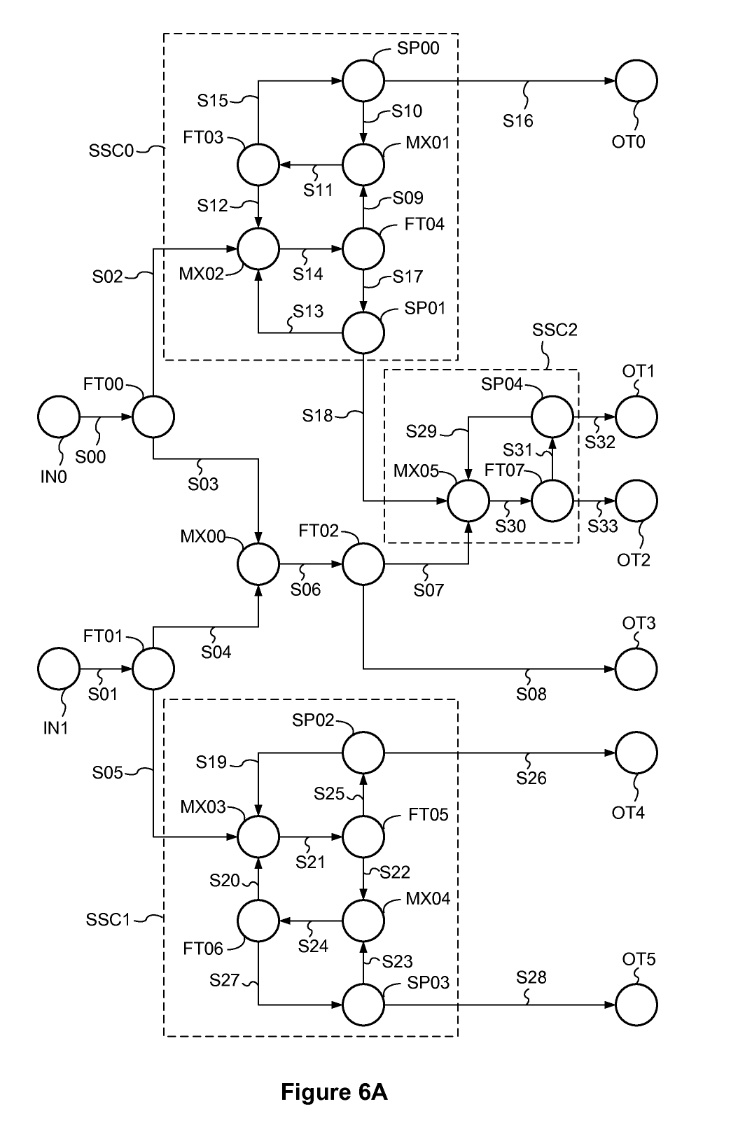

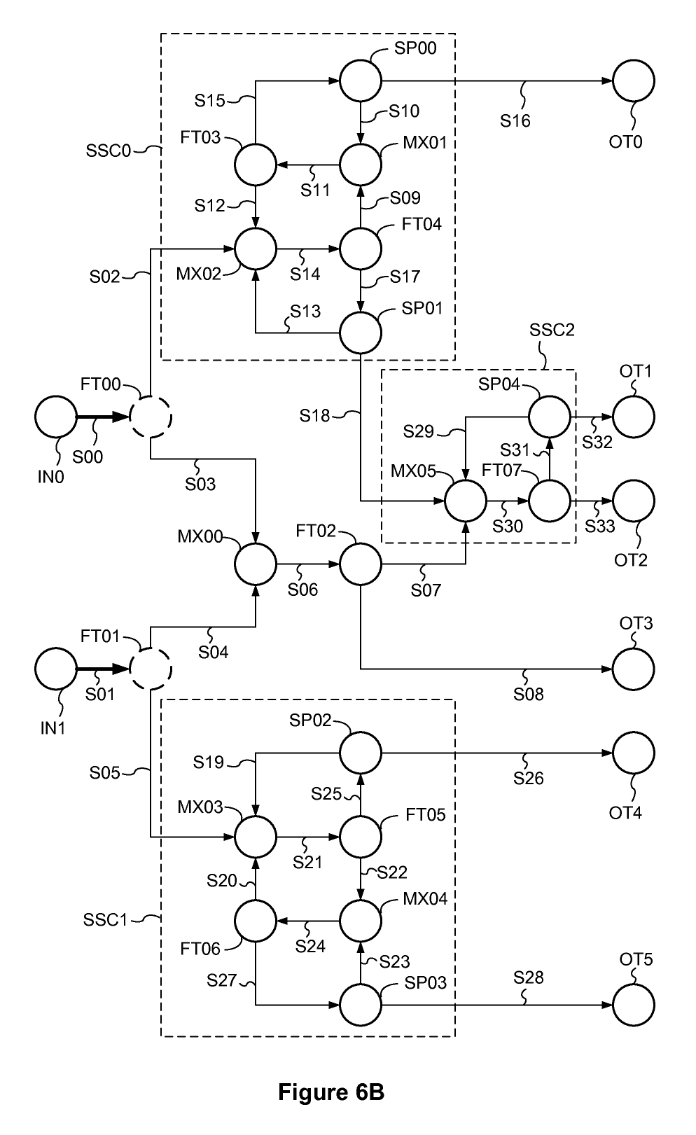

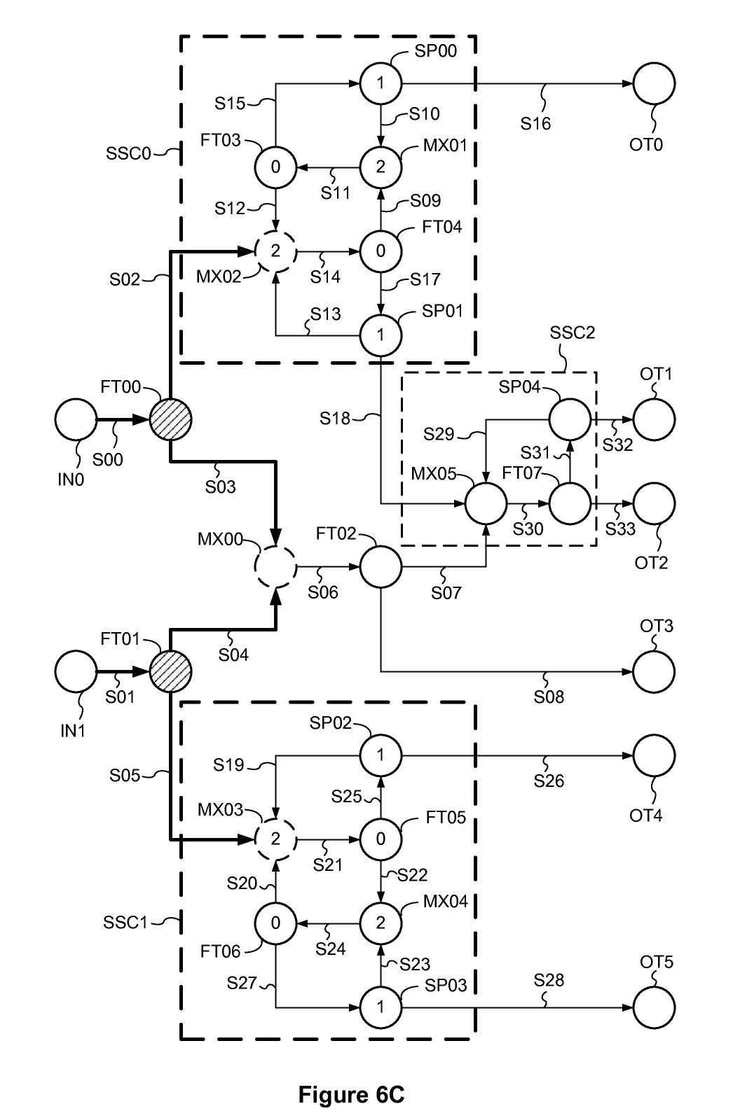

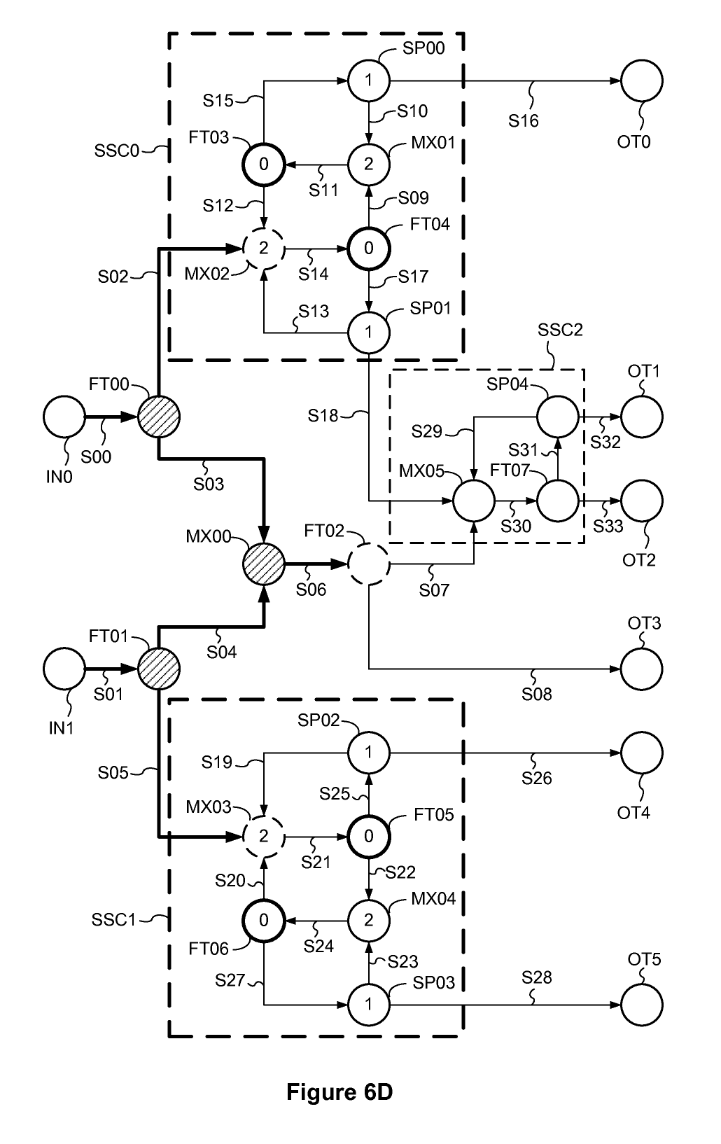

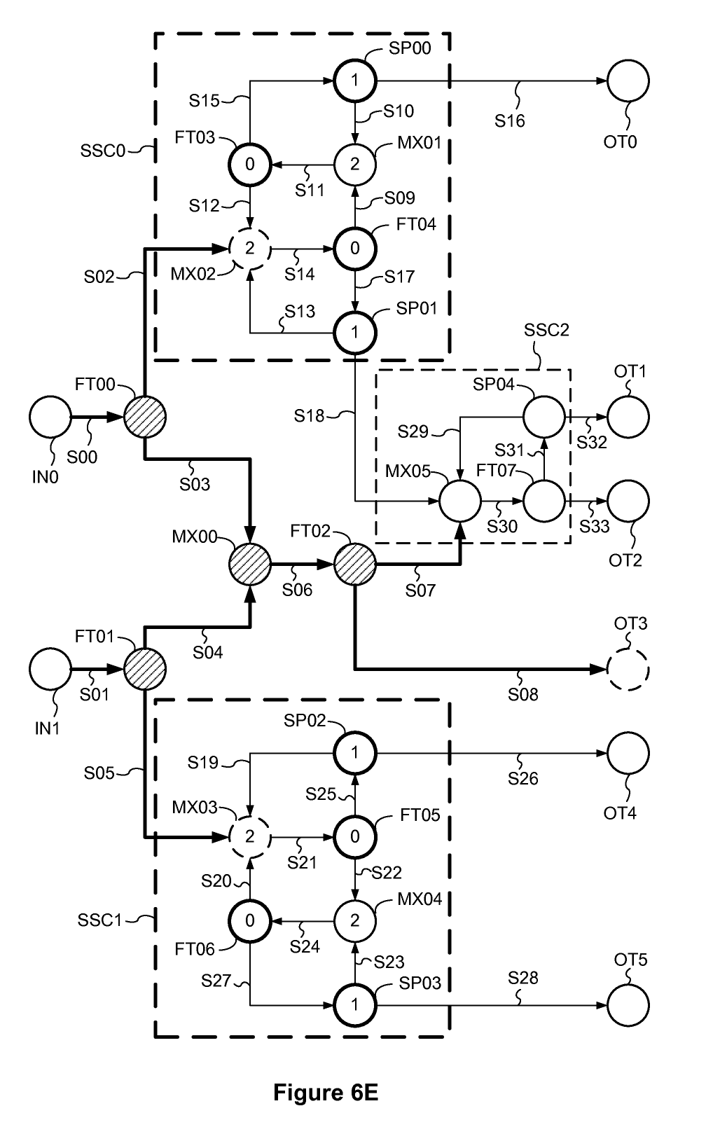

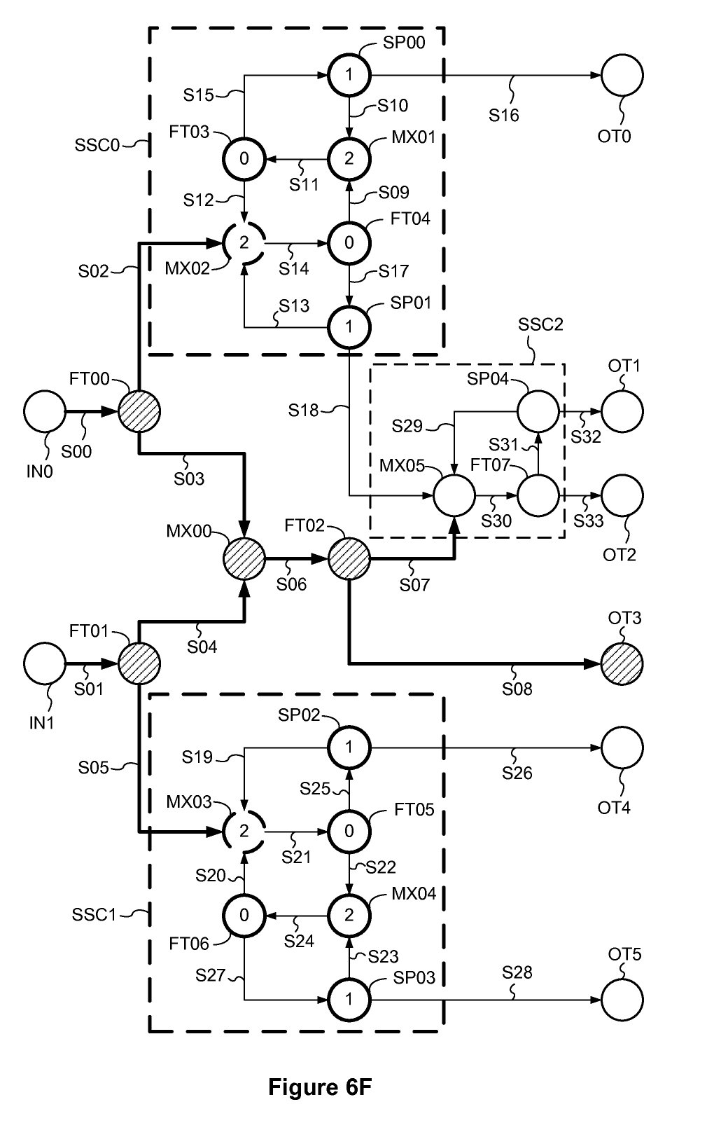

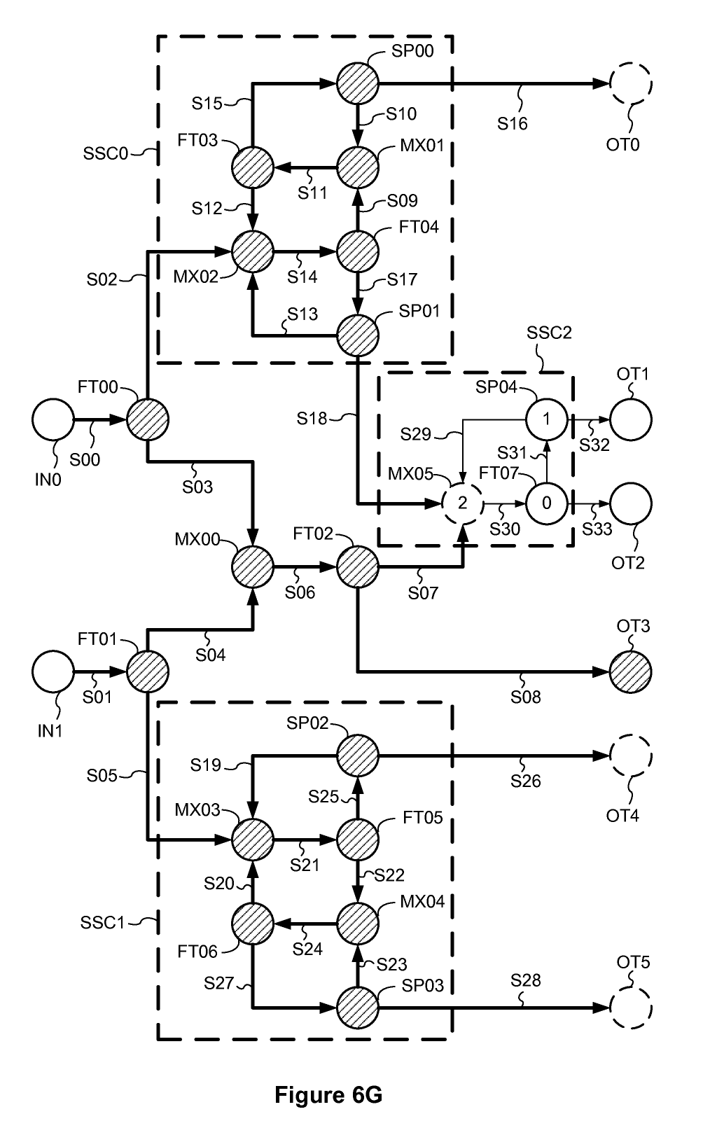

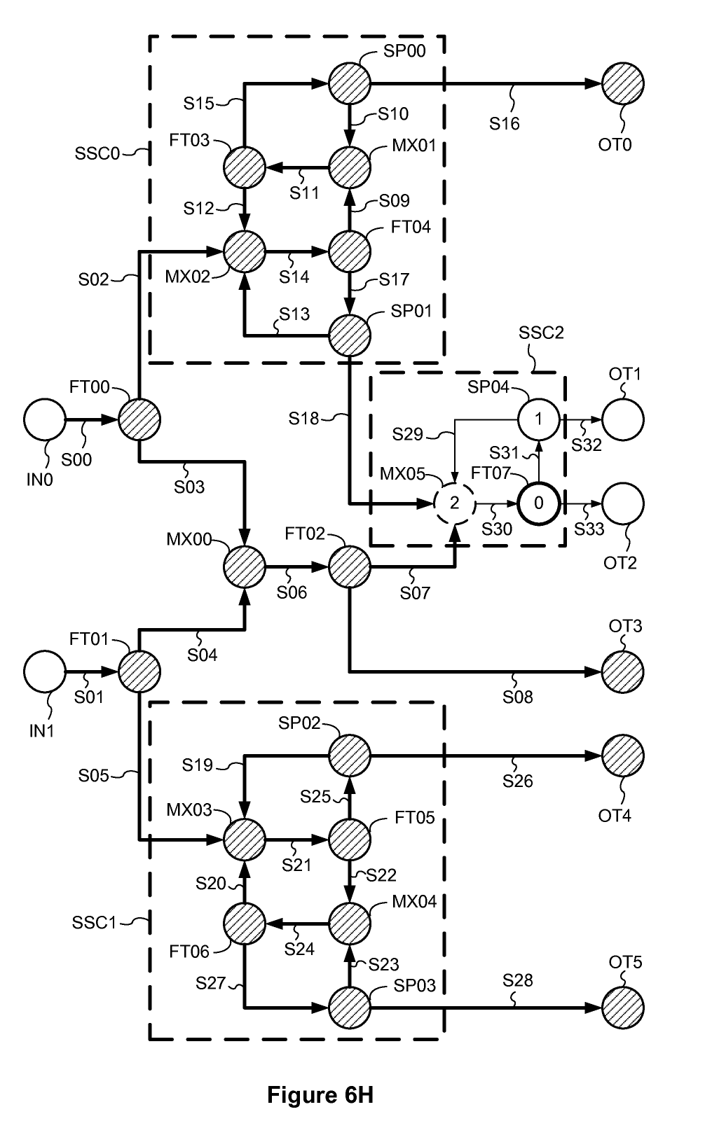

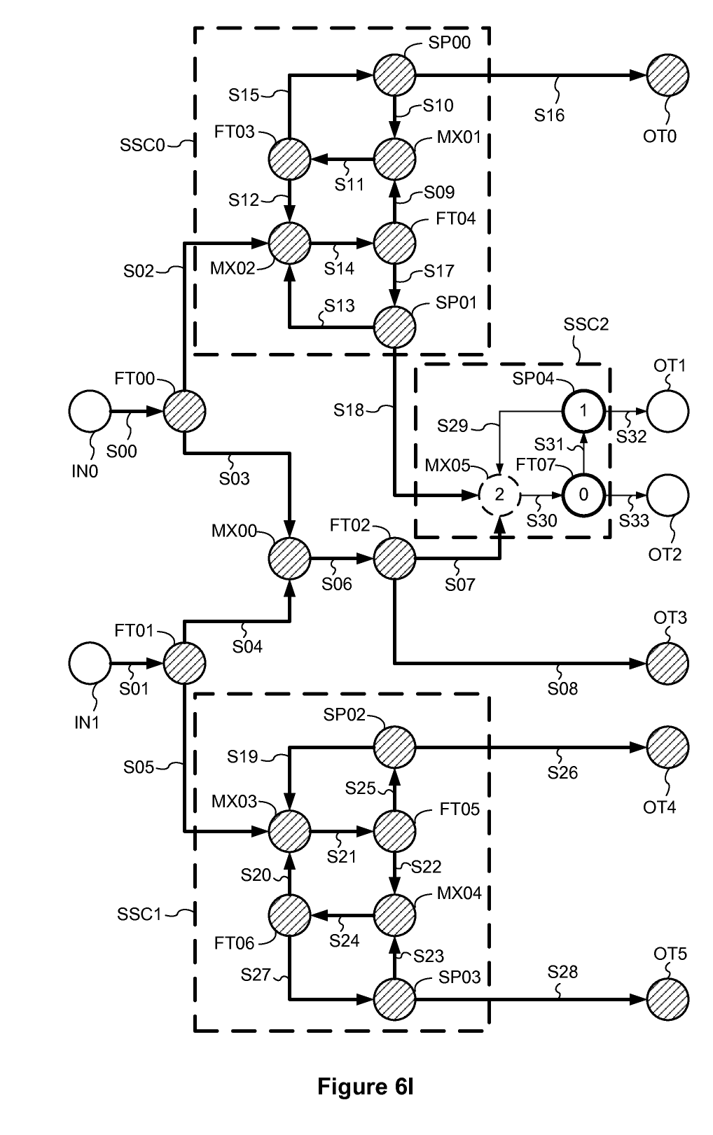

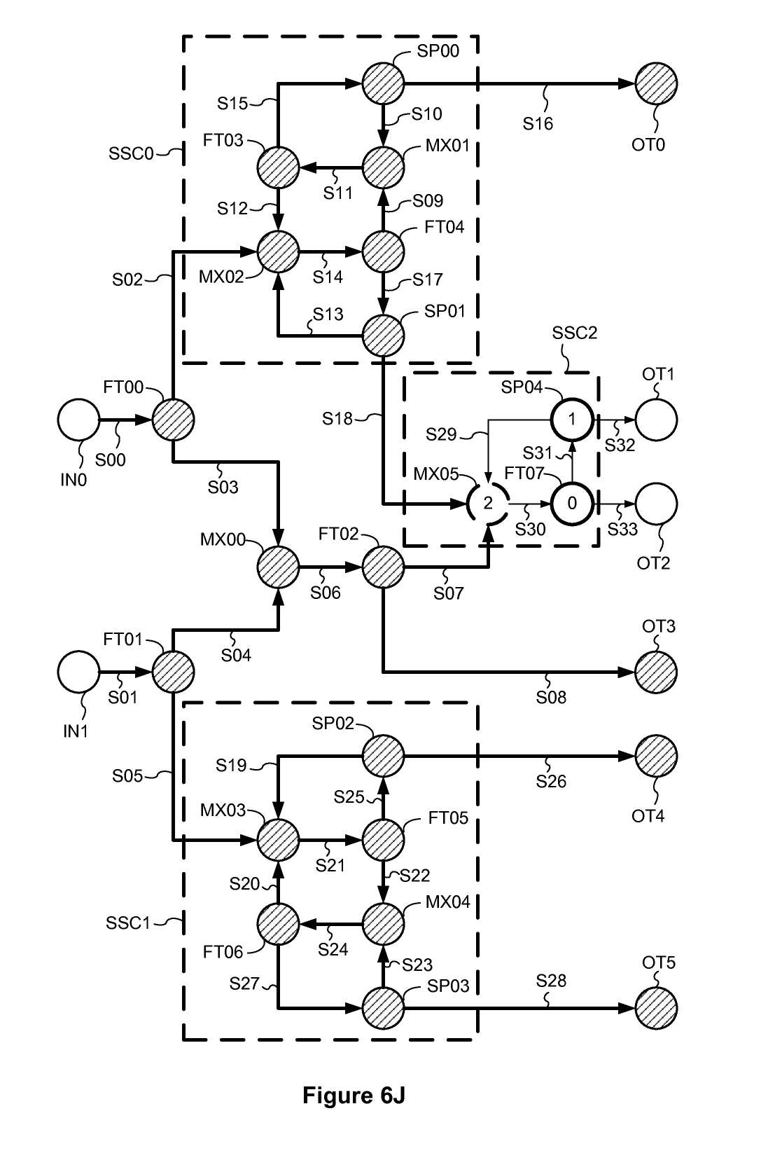

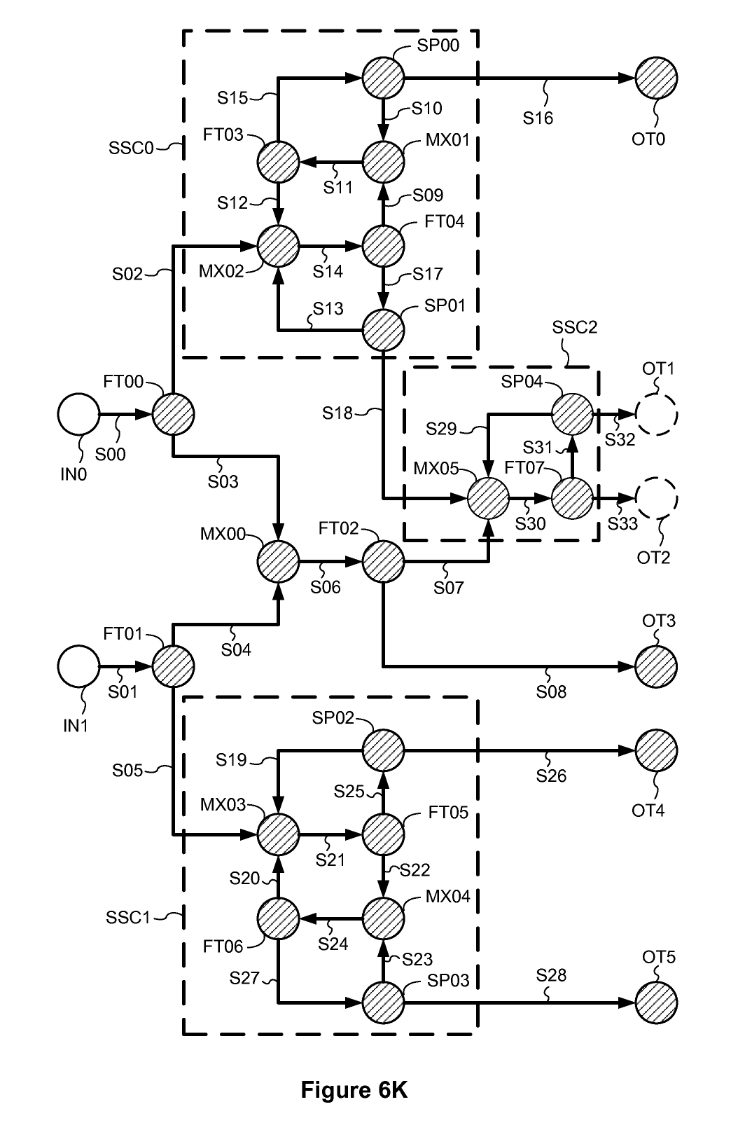

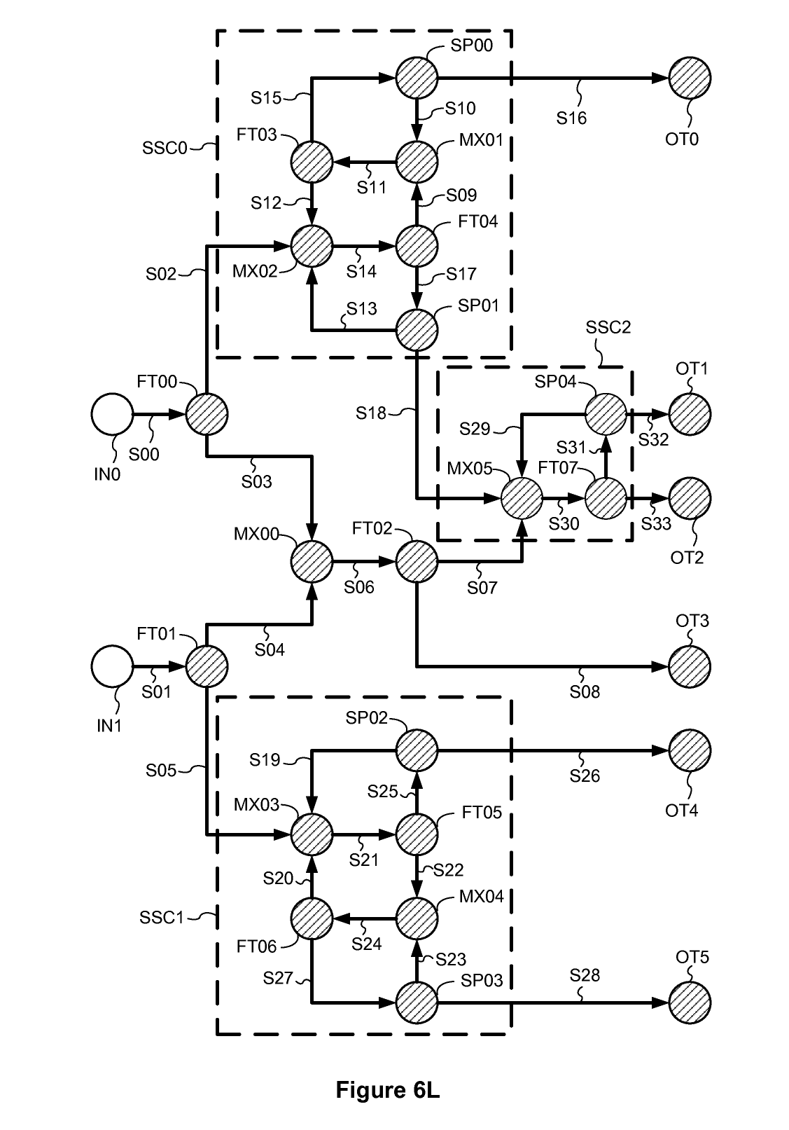

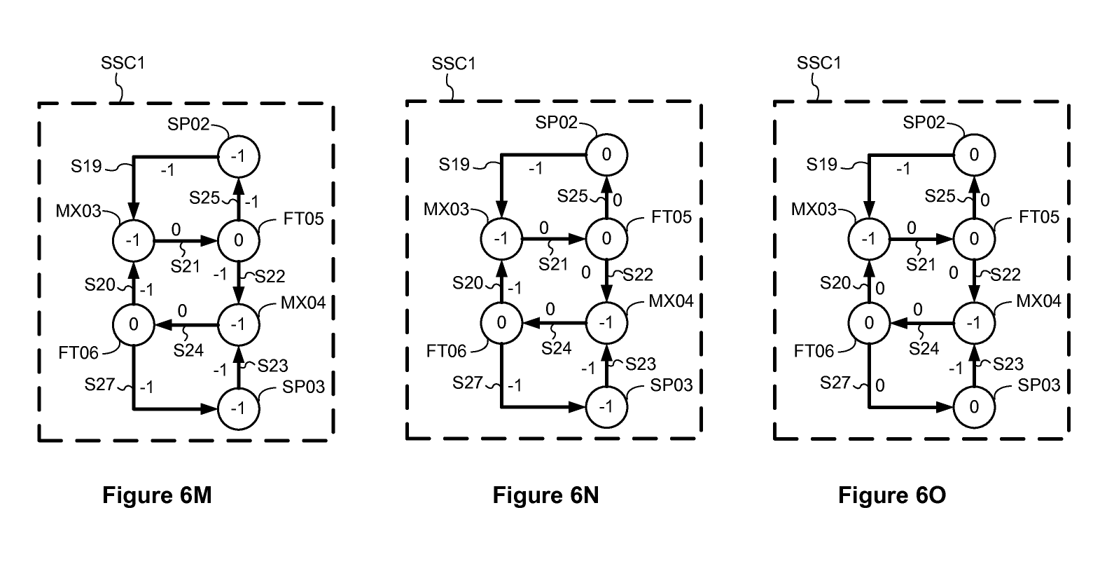

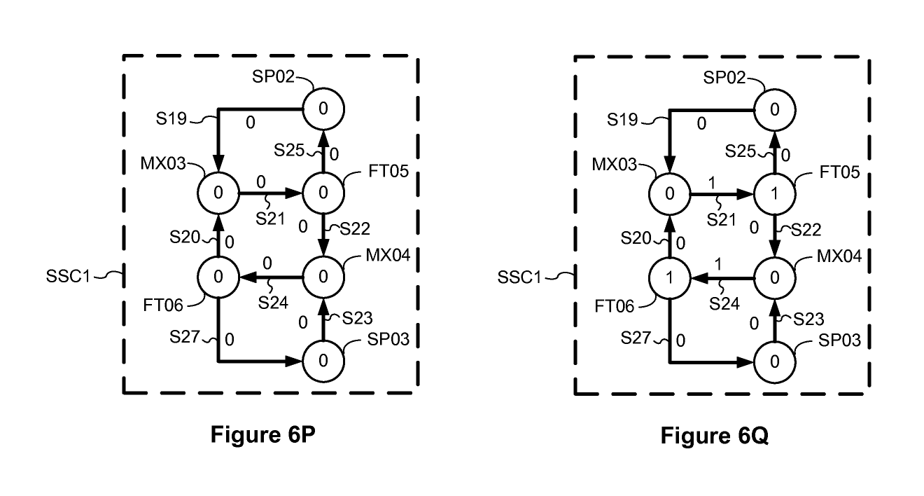

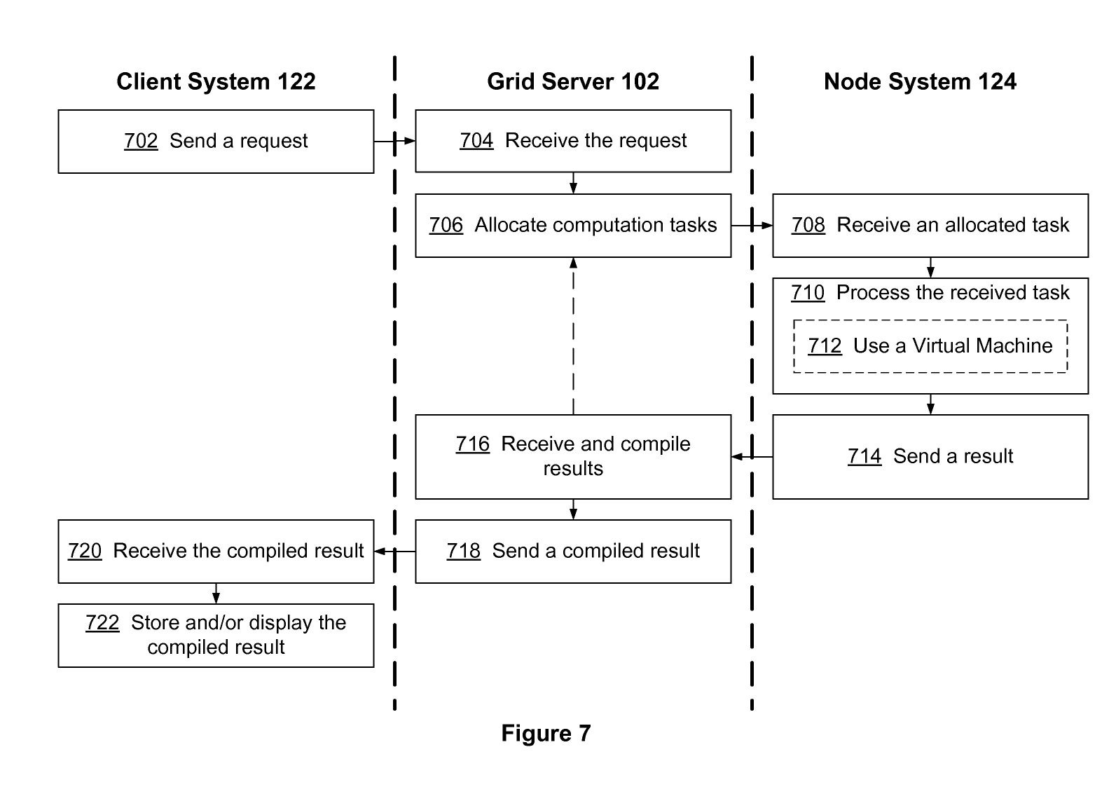

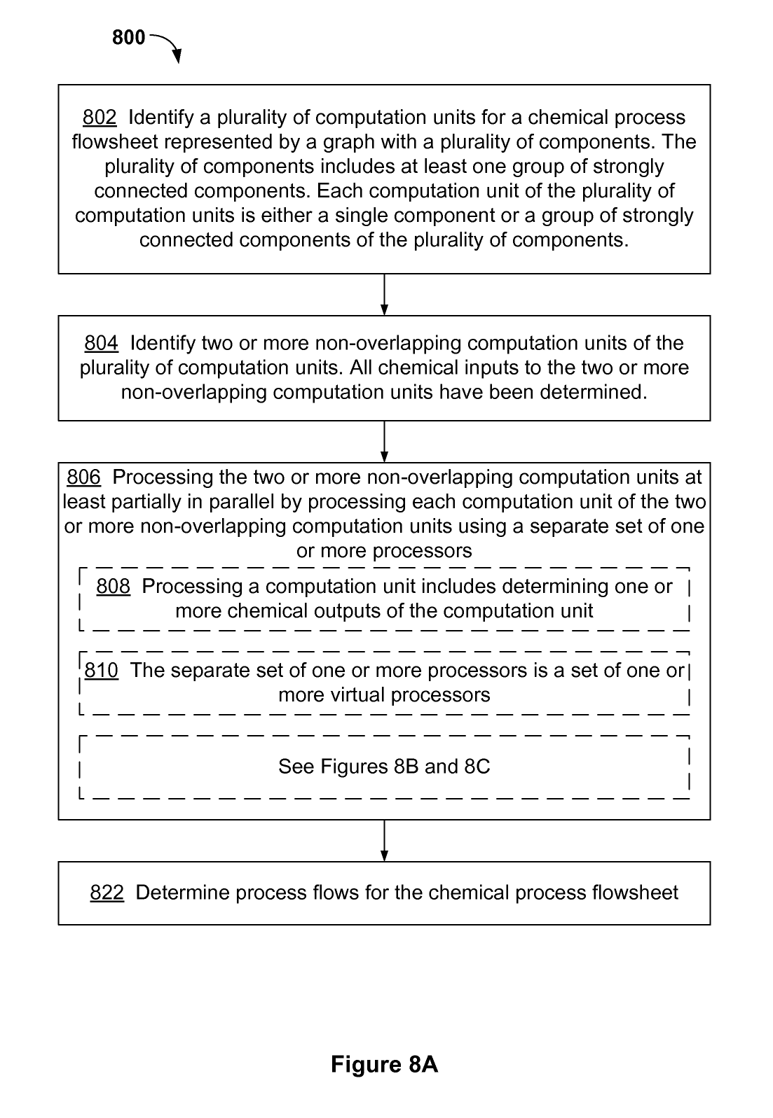

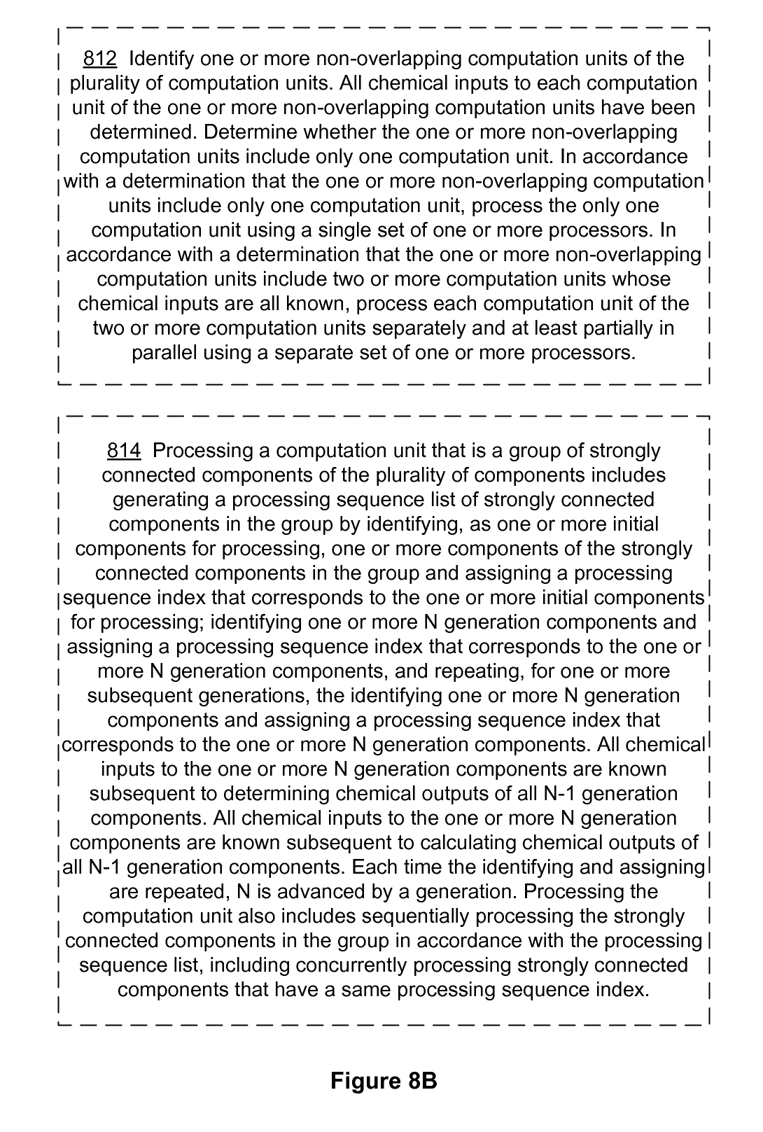

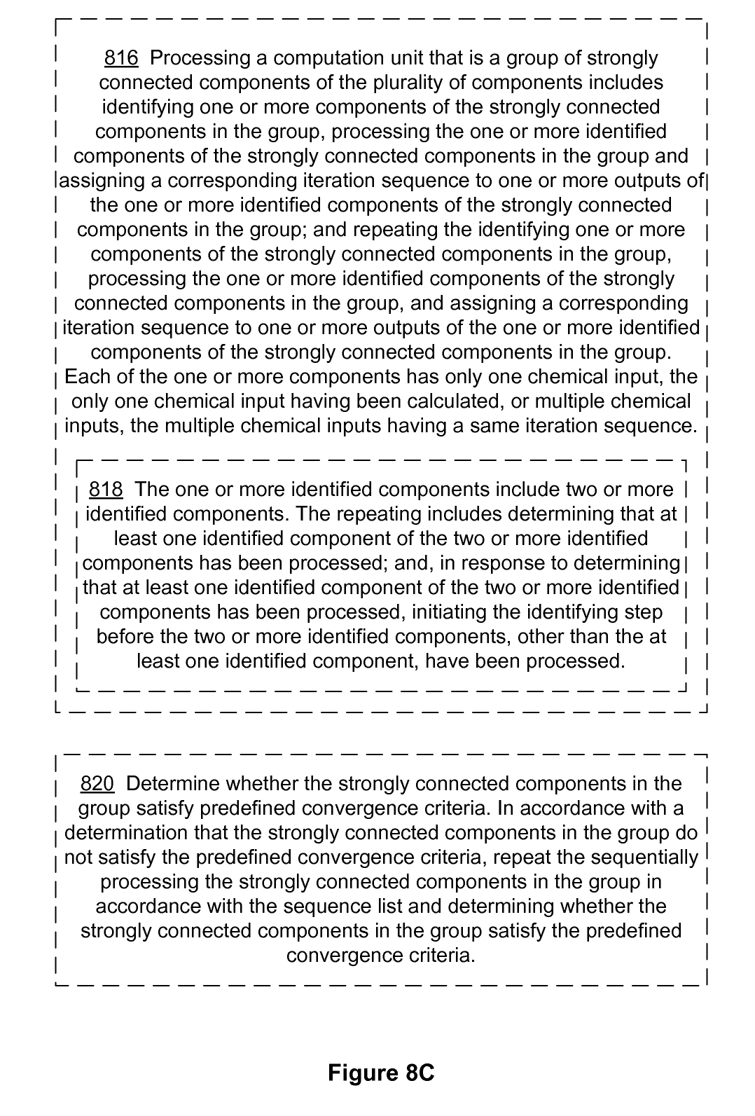

FIGS. 2-5 illustrate computer systems that are used for identifying chemical processes that can be simulated simultaneously. FIGS. 6A-6Q illustrate simulating chemical processes for a chemical process flowsheet, including simultaneous simulation of certain chemical processes. FIG. 7 illustrates operations performed by computer systems in simulating chemical processes. FIGS. 8A-8C illustrate a method for determining chemical process flows for a chemical process flowsheet.

FIG. 2 is a block diagram illustrating a distributed computer system 100 in accordance with some embodiments. In FIG. 2, system 100 includes a grid server 102 and a plurality of node systems 124 (e.g., node system 124-1 through node system 124-M), and communication networks 120. In some embodiments, the distributed computer system 100 includes a plurality of client systems 122 (e.g., client system 122-1 through client system 122-N).

A client system 122 can be any computing device (e.g., a laptop computer, a desktop computer, a mobile phone, a handheld computer, etc.). The client system 122 typically includes a graphical user interface (GUI) for graphically displaying received information. The client system 122 is connected to a grid server 102 via communication networks 120.

The grid server 102 is a computer server configured to interact with node systems 124. In some embodiments, the grid server 102 includes a client module 104 and a node system module 110.

In some embodiments, the client module 104 includes a receiving module 106 for receiving a request from a client system 122 and a presentation module 108 for sending a response to the client system 122.

In some embodiments, the node system module 110 includes an allocation module 112 configured for allocating simulation tasks to the node systems 124 and a result processing module 114 configured for combining results from the node systems 124.

In some embodiments, the grid server 102 includes a model database 116 for storing one or more chemical process models (e.g., flowsheets) and/or a result database 118 for storing simulation results.

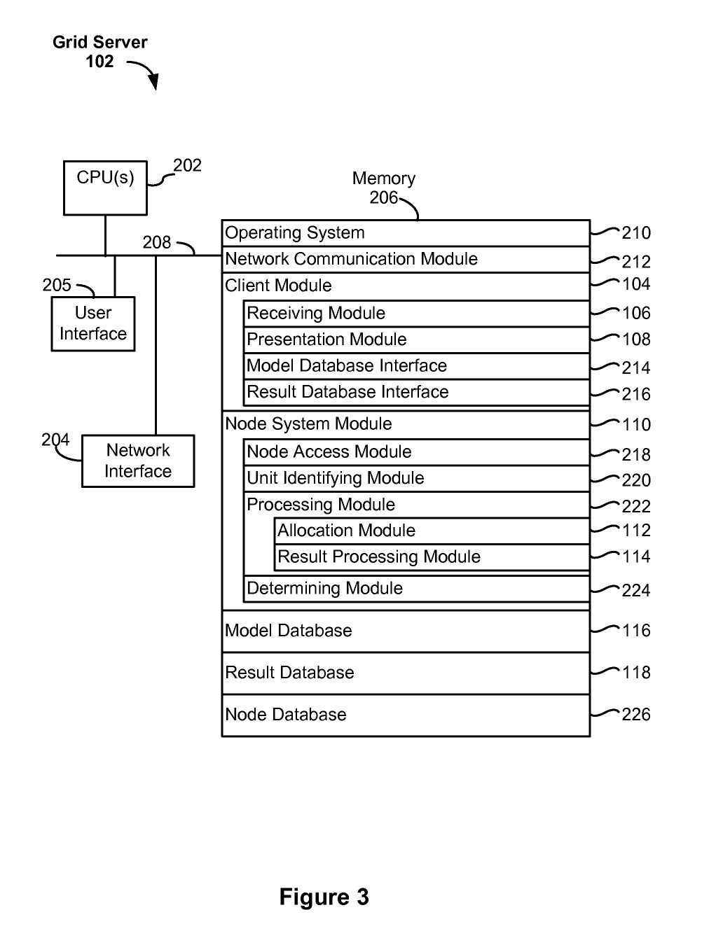

FIG. 3 is a block diagram illustrating a grid server 102 in accordance with some embodiments.

The grid server 102 includes one or more processing units CPU(s) 202, one or more network or other communication interfaces 204, memory 206, and one or more communication buses 208 for interconnecting these components. In some embodiments, the grid server 102 includes a user interface 205 comprising a display device and one or more input devices, such as a keyboard, mouse, touchpad, touch screen and/or other input devices.

Memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 206 optionally includes one or more storage devices remotely located from the CPU(s) 202. Memory 206, or alternatively the non-volatile memory device(s) within memory 206, comprises a non-transitory computer readable storage medium. In some embodiments, memory 206 or alternatively the non-transitory computer readable storage medium stores the following programs, modules and data structures, or a subset thereof:
Operating System 210 that includes procedures for handling various basic system services and for performing hardware dependent tasks;
Network Communication Module (or instructions) 212, configured for connecting the grid server 102 to other computers (e.g., node systems 124, client system 122, etc.) via one or more network interfaces 204 (wired or wireless) and one or more communication networks 120 (FIG. 2), such as the Internet, other wide area networks, local area networks, metropolitan area networks, and so on;
Client Module 104;
Node System Module 110;
Model Database 116; and
Result Database 118.

In some embodiments, the client module 104 includes the following components, or a subset or a superset thereof:
Receiving Module 106;
Presentation Module 108;
Model Database Interface 214 configured for accessing the Model Database 116 to retrieve and/or store data (e.g., information representing chemical process flowsheets); and
Result Database Interface 216 configured for accessing the Result Database 118 to retrieve and/or store data (e.g., simulation results).

In some embodiments, the node system module 110 includes the following components, or a subset or a superset thereof:
Node Access Module 218 configured for communications with node systems 124 in FIG. 2 (e.g., sending simulation tasks to the node systems, receiving results from the node systems, and/or monitoring the node systems, such as monitoring computing loads on node systems and/or identifying which node systems are available for processing additional tasks);
Unit Identifying Module 220 configured for identifying one or more computation units in a chemical process flowsheet;
Processing Module 222 configured for processing computation units represented by the chemical process flowsheet; and
Determining Module 224 configured for determining process flows for a chemical process flowsheet.

In some embodiments, the processing module 222 includes the allocation module 112 and the result processing module 114. In some embodiments, the allocation module 112 allocates tasks based at least on computing loads on node systems. In some embodiments, the allocation module 112 allocates tasks also based on the condition of communication network(s) 120 (e.g., whether a network connection to a particular node system is congested). In some embodiments, the result processing module 114 processes results returned by node systems and stores them in the result database 118 and/or pass the results to the client system 122-1.

In some embodiments, the memory includes Node Database 226, which includes information identifying node systems 124 (FIG. 2) that are available to the grid server 102 (e.g., node systems that are configured to receive simulation tasks from the grid server 102). In some embodiments, the Node Database 226 also includes information used for communicating with the node systems 124, such as communication protocols, security protocols, data format, etc. The information in the Node Database 226 is typically used by the Node Access Module 218 in communications with the node systems 124.

Each of the above identified elements may be stored in one or more of the previously mentioned memory devices, and corresponds to a set of instructions for performing a function described above. The above identified modules or programs (e.g., sets of instructions) need not be implemented as separate software programs, procedures or modules, and thus various subsets of these modules may be combined or otherwise re-arranged in various embodiments. In some embodiments, memory 206 stores a subset of the modules and data structures identified above. Furthermore, in some embodiments, memory 206 stores additional modules and data structures not described above.

Although FIG. 3 shows the Grid Server 102 in accordance with some embodiments, as recognized by those of ordinary skill in the art, items shown separately could be combined and some items could be separated. For example, the client module 104 and the node system module 110 may be combined in a single module.

Some items shown separately in FIG. 3 could be implemented on single servers and single items could be implemented by one or more servers. For example, in some embodiments, the client application 104 and the node system module 110 are implemented in separate servers. The actual number of servers used to implement the Grid Server 102 and how features are allocated among them will vary from one implementation to another, and optionally depends in part on the amount of data traffic that the server must handle during peak usage periods as well as during average usage periods.

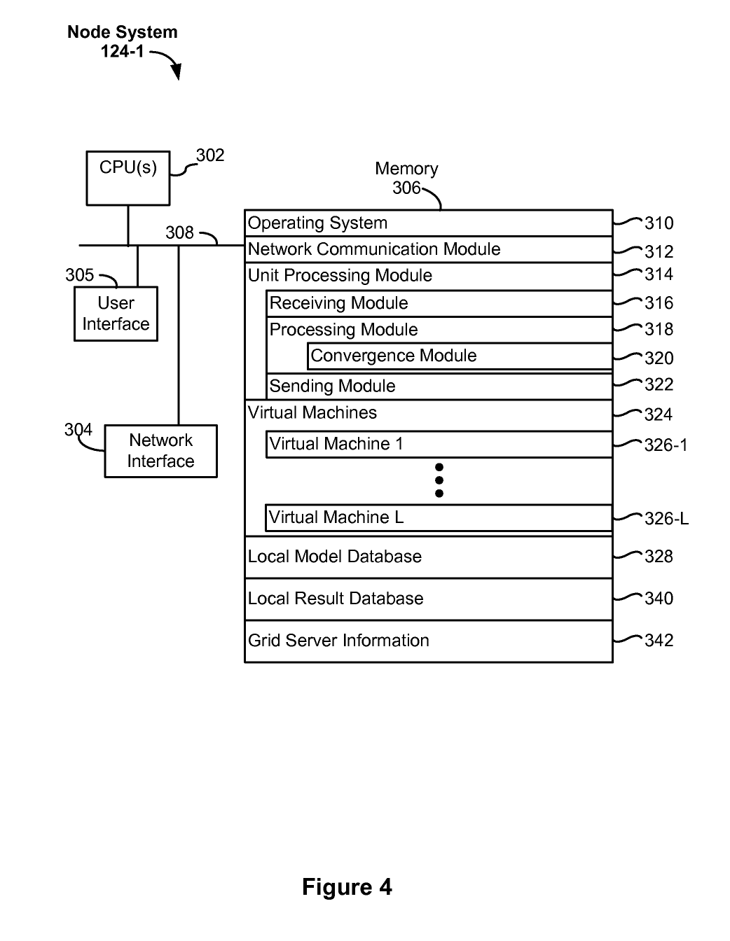

FIG. 4 is a block diagram illustrating a node system 124-1 in accordance with some embodiments.

The node system 124-1 includes one or more processing units CPU(s) 302, one or more network or other communication interfaces 304, memory 306, and one or more communication buses 308 for interconnecting these components. In some embodiments, the node system 124-1 includes a user interface 305 comprising a display device and one or more input devices, such as a keyboard, mouse, touchpad, touch screen and/or other input devices.

Memory 306 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 306 optionally includes one or more storage devices remotely located from the CPU(s) 302. Memory 306, or alternatively the non-volatile memory device(s) within memory 306, comprises a non-transitory computer readable storage medium. In some embodiments, memory 306 or alternatively the non-transitory computer readable storage medium stores the following programs, modules and data structures, or a subset thereof:
Operating System 310 that includes procedures for handling various basic system services and for performing hardware dependent tasks;
Network Communication Module (or instructions) 312, configured for connecting the node system 124-1 to other computers (e.g., grid server 102, etc.) via one or more network interfaces 304 (wired or wireless) and one or more communication networks 120 (FIG. 2), such as the Internet, other wide area networks, local area networks, metropolitan area networks, and so on;
Unit Processing Module 314 configured for processing a task corresponding to a computation unit allocated to the node system 124-1;
Virtual Machines 324 that include instructions and data to operate one or more virtual machines, such as Virtual Machine 1 (326-1) through Virtual Machine L (326-L);
Local Model Database 328 storing information identifying a subset of the chemical process flowsheet (e.g., a portion of the chemical process flowsheet that corresponds to a task allocated to the node system 124-1);
Local Result Database 330 storing one or more results from processing the computation unit allocated to the node system 124-1; and
Grid Server Information 332 identifying the grid server 102 (FIG. 2) and/or information used for communications with the grid server 102 (e.g., communications protocol and/or security protocols, etc.).

In some embodiments, the unit processing module 314 includes the following components, or a subset or a superset thereof:
Receiving Module 316 configured for receiving simulation tasks from the grid server 102 (FIG. 2);
Processing Module 318 configured for processing the simulation tasks (e.g., performing simulations); and
Sending Module 322 configured for sending simulation results to the grid server 102.

In some embodiments, the processing module 318 includes Convergence Module 320 configured for determining whether one or more simulation results satisfy convergence criteria.

Each of the above identified elements may be stored in one or more of the previously mentioned memory devices, and corresponds to a set of instructions for performing a function described above. The above identified modules or programs (e.g., sets of instructions) need not be implemented as separate software programs, procedures or modules, and thus various subsets of these modules may be combined or otherwise re-arranged in various embodiments. In some embodiments, memory 306 stores a subset of the modules and data structures identified above. Furthermore, in some embodiments, memory 306 stores additional modules and data structures not described above.

Although FIG. 4 shows the node system 124-1 in accordance with some embodiments, as recognized by those of ordinary skill in the art, items shown separately could be combined and some items could be separated. For example, the receiving module 316 and the sending module 322 may be combined in a single module.

Although FIG. 4 illustrates the node system 124-1, other node systems (e.g., node system 124-M, FIG. 2) may have a structure analogous to the structure of the node system 124-1.

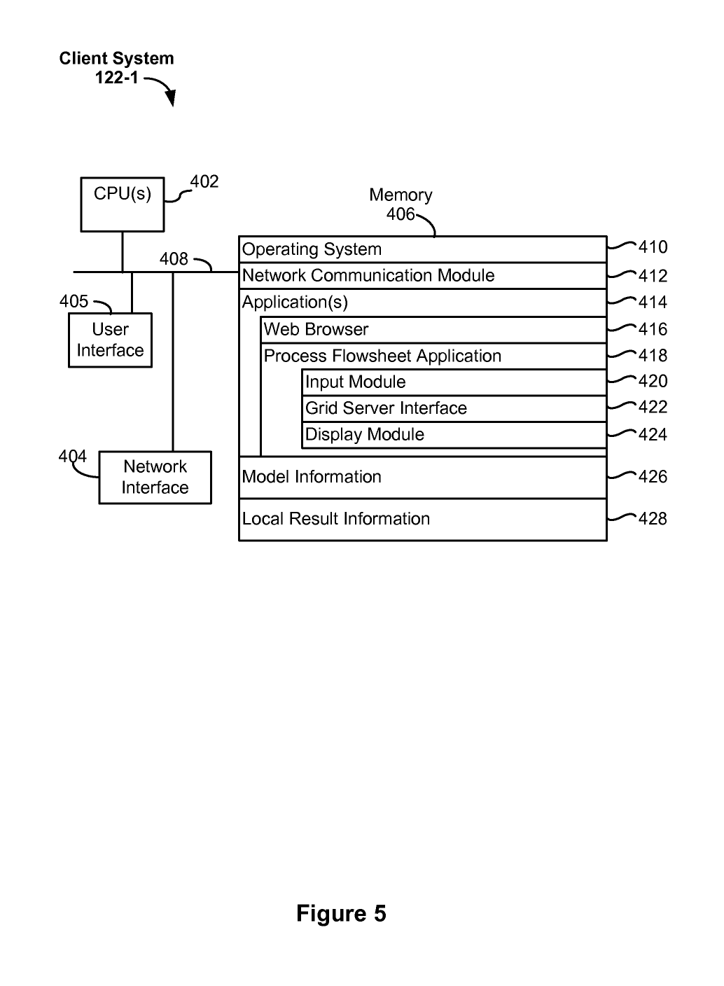

FIG. 5 is a block diagram illustrating a client system 122-1 in accordance with some embodiments.

The client system 122-1 includes one or more processing units CPU(s) 402, one or more network or other communication interfaces 404, memory 406, and one or more communication buses 408 for interconnecting these components. The client system 122-1 also includes a user interface 405 comprising a display device and one or more input devices, such as a keyboard, mouse, touchpad, touch screen and/or other input devices.

Memory 406 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 406 optionally includes one or more storage devices remotely located from the CPU(s) 402. Memory 406, or alternatively the non-volatile memory device(s) within memory 406, comprises a non-transitory computer readable storage medium. In some embodiments, memory 406 or alternatively the non-transitory computer readable storage medium stores the following programs, modules and data structures, or a subset thereof:
Operating System 410 that includes procedures for handling various basic system services and for performing hardware dependent tasks;
Network Communication Module (or instructions) 412, configured for connecting the client system 122-1 to other computers (e.g., grid server 102, etc.) via one or more network interfaces 404 (wired or wireless) and one or more communication networks 120 (FIG. 2), such as the Internet, other wide area networks, local area networks, metropolitan area networks, and so on; and
One or more Applications 414.

In some embodiments, the one or more applications 414 include a web browser, which is used for accessing the grid server 102 (e.g., through an HTML-based user interface).

In some embodiments, the one or more applications 414 include Process Flowsheet Application 418 configured for requesting a simulation of a chemical process flowsheet and/or displaying a result of the simulation. The Process Flowsheet Application 418 includes the following programs, modules and data structures, or a superset or a subset thereof:
Input Module 416 configured for processing a received user input;
Grid Server Interface 422 used for communications with the grid server 102 (e.g., sending a chemical process flowsheet or a corresponding model, or a portion thereof to the grid server 102 and receiving results from the grid server 102); and
Display Module 424 configured for preparing displaying a graphical user interface on the display device of the client system 122-1.

In some embodiments, the memory 406 includes model information 426 that represents one or more chemical process flowsheets. For example, information representing a chemical process flowsheet may be sent to the grid server 102 by the grid server interface 422 of the process flowsheet application 418 to initiate processing of the chemical process flowsheet.

In some embodiments, the memory 406 includes local result information 428 representing a result of processing the chemical process flowsheet. Information in the local result information 428 is typically received from the grid server 102 and retrieved for displaying the information using a graphical user interface on the display device of the client system 122-1.

Each of the above identified elements may be stored in one or more of the previously mentioned memory devices, and corresponds to a set of instructions for performing a function described above. The above identified modules or programs (e.g., sets of instructions) need not be implemented as separate software programs, procedures or modules, and thus various subsets of these modules may be combined or otherwise re-arranged in various embodiments. In some embodiments, memory 406 stores a subset of the modules and data structures identified above. Furthermore, in some embodiments, memory 406 stores additional modules and data structures not described above.

Although FIG. 5 shows the client system 122-1 in accordance with some embodiments, as recognized by those of ordinary skill in the art, items shown separately could be combined and some items could be separated.

Although FIG. 5 illustrates the client system 122-1, other client systems (e.g., client system 122-N, FIG. 2) may have a structure analogous to the structure of the client system 122-1.

As shown above, FIGS. 2-5 illustrate a distributed computer system in which the grid server 102 performs various tasks including such as identifying one or more computation units in a chemical process flowsheet and combining results sent by the node systems.

In some embodiments, the client system 122-1 performs one or more of these tasks (e.g., identifying one or more computation units in a chemical process flowsheet and combining results sent by the node systems). In such embodiments, the grid server 102 may serve as a gateway to the node systems. In some embodiments, the grid server 102 does not include the model database 116, and the client system 122-1 sends instructions with information that corresponds to a portion of a chemical process flowsheet. In some embodiments, the client system 122-1 includes the convergence module 320 so that the client system 122-1 determines whether one or more simulation results from a node system satisfy convergence criteria.

In some embodiments, the node systems 124 perform one or more of these tasks (e.g., identifying one or more computation units in a chemical process flowsheet and combining results sent by the node systems). In some embodiments, one or more of the node systems 124 include the model database 116. In some embodiments, the node systems 124 are configured to communicate with one another without going through the grid server 102.

FIGS. 6A-6Q illustrate determining chemical flows for a chemical process flowsheet in accordance with some embodiments.

FIG. 6A illustrates a graph that corresponds to the chemical process flowsheet shown in FIG. 1, in accordance with some embodiments. In FIG. 6A, chemical process components, such as vessels, mixers, and splits, in the chemical process flowsheet are represented as nodes in the graph. In addition, chemical flows between the chemical process components are represented as edges in FIG. 6A.

FIG. 6A also illustrates that groups of strongly connected components (e.g., SSC0, SSC1, and SSC2) are identified. In some embodiments, groups SSC0 and SSC1 are simulated concurrently. As used herein, a group of strongly connected components refers to a group of components, wherein each component in the group is reachable from every other component in the group (e.g., there is a path from each component in the group to every other component in the group). In some embodiments, the strongly connected components are identified using a depth first search. For example, each loop that is identified using the depth first search and is not directly connected with another loop indicates a presence of a separate group of strongly connected components.

In FIG. 6B, chemical flows S00 and S01 are highlighted to indicate that parameters (e.g., flow rates, chemical composition, etc.) of the chemical flows S00 and S0l are known.

FIG. 6B also illustrates that the node FT00 is ready for simulation, because all input (e.g., S00) to the node FT00 is known. Similarly, the node FT01 is ready for simulation, because all input (e.g., S01) to the node FT01 is known.

FIG. 6C, illustrates that outputs (e.g., S02, S03, S04, and S05) of the nodes FT00 and FT01 are known from simulation. In FIG. 6C, chemical flows S02, S03, S04, and S05 are highlighted to indicate that parameters of the chemical flows S02, S03, S04, and S05 are known.

FIG. 6C also illustrates that the group SSC0 of strongly connected components is ready for simulation, because all input (e.g., S02) to the group SSC0 is known. Similarly, the group SSC1 of strongly connected components is ready for simulation, because all input (e.g., S05) to the group SSC1 is known. In addition, the node MX00 is ready for simulation because all inputs (e.g., S03 and S04) to the node MX00 are known.

In FIG. 6C, the nodes FT03 and FT04 are identified as initial components for simulation in the group SSC0. The nodes FT03 and FT04 are labeled “0” to indicate that the nodes FT03 and FT04 are 0-th order components (i.e., initial components) in a processing sequence index for the group SSC0. The node SP00, which receives an input only from a 0-th order component (e.g., FT03), is identified as a first order component (labeled “1”) in the processing sequence index. Similarly, the node SP01, which receives an input only from a 0-th order component (e.g., FT04), is identified as a first order component in the processing sequence index. The node MX01, which receives an input from a first order component (e.g., SP00) in addition to an input from a 0-th order component (e.g., FT04), is identified as a second order component (labeled “2”). Similarly, the node MX02, which receives an input from a first order component (e.g., SP01) in addition to an input from a 0-th order component (e.g., FT03), is identified as a second order component.

Similarly, the nodes FT05 and FT06 are identified as 0-th order components (i.e., initial components) in a processing sequence index for the group SSC1, the nodes SP02 and SP03 are identified as first order components, and MX03 and MX04 are identified as second order components.

FIG. 6D illustrates that the output (e.g., S06) of the node MX00 is known from simulation. In FIG. 6D, the chemical flow S06 is highlighted to indicate that parameters of the chemical flow S06 is known.

FIG. 6D also illustrates that the node FT02 is ready for simulation, because all input (e.g., S06) to the node FT02 is known.

In the group SSC0, the strongly connected components form one or more loops of chemical process flows. Partitioning these components enables processing these components at least partially in sequence so that not all of the components in the group SSC0 need to be processed simultaneously. This procedure is called tearing. In FIG. 6D, the nodes FT03 and FT04 in the group SSC0 are highlighted to indicate that the nodes FT03 and FT04 are simulated. For example, the node FT03 is simulated using an estimated input S11, and the node FT04 is simulated using an estimated input S14. The outputs S12 and S15 of the node FT03 and the outputs S09 and S17 of the node FT04 are determined from the simulation. In other words, providing estimated inputs S11 and S14 allows the components in the group SSC0 to be processed iteratively.

Similarly, the nodes FT05 and FT06 in the group SSC1 are highlighted to indicate that the nodes FT05 and FT06 are simulated. The outputs S25 and S22 of the node FT05 and the outputs S20 and S27 of the node FT06 are determined from the simulation.

FIG. 6E illustrates that the outputs (e.g., S07 and S08) of the node FT02 are known from simulation. In FIG. 6E, the chemical flows S07 and S08 are highlighted to indicate that parameters of the chemical flows S07 and S08 are known.

FIG. 6E also illustrates that the node OT3 can be determined, because all input to the node OT3 (e.g., S08) is known.

In FIG. 6E, the nodes SP00 and SP01 in the group SSC0 are highlighted to indicate that the nodes SP00 and SP01 are simulated. The outputs S10 and S16 of the node SP00 and the outputs S13 and S18 of the node SP01 are determined from the simulation. The outputs S10 and S13 are used for processing subsequent components in the group SSC0. The outputs S16 and S18 are typically not used for processing subsequent components (e.g., OT0 and MX05) until their convergence is confirmed.

Similarly, the nodes SP02 and SP03 in the group SSC1 are highlighted to indicate that the nodes SP02 and SP03 are simulated. The outputs S19 and S26 of the node SP02 and the outputs S23 and S28 of the node SP03 are determined from the simulation. The outputs S19 and S23 are used for processing subsequent components in the group SSC1. The outputs S26 and S28 are typically not used for processing subsequent components (e.g., OT4 and OT5) until their convergence is confirmed.

In FIG. 6F, the nodes MX01 and MX02 in the group SSC0 are highlighted to indicate that the nodes MX01 and MX02 are simulated. The output S11 of the node MX01 and the output S14 of the node MX02 are determined from the simulation.

Similarly, the nodes MX03 and MX04 in the group SSC1 are highlighted to indicate that the nodes MX03 and MX04 are simulated. The output S21 of the node MX03 and the output S24 of the node MX04 are determined from the simulation.

After the nodes MX01 and MX02 are simulated, it is determined whether the output S11 of the node MX01 converges and whether the output S14 of the node MX02 converges. For example, it is determined whether the output S11 of the node MX01 matches the estimated S11 (used for simulating FT03 to start the simulation of the group SSC0) and whether the output S14 of the node MX02 matches the estimated S14 (used for simulating FT04 to start the simulation of the group SSC0). If any of the output S11 of the node MX01 or the output S14 of the node MX02 does not converge, simulation of the nodes in the group SSC0 is repeated. After the repetition, it is determined whether the output S11 of the node MX01 converges and whether the output S14 of the node MX02 converges. For example, it is determined whether the output S11 of the node MX01 matches the previous S11 and whether the output S14 of the node MX02 matches the previous S14.

Similarly, after the nodes MX03 and MX04 are simulated, it is determined whether the output S21 of the node MX03 converges and whether the output S24 of the node MX04 converges. If any of the output S21 of the node MX03 or the output S24 of the node MX04 does not converge, simulation of the nodes in the group SSC1 is repeated.

FIG. 6G illustrates that the output S11 of the node MX01 converges and the output S14 of the node MX02 converges. Thus, chemical flows within the group SSC0 (e.g., S09, 510, S11, S12, S13, S14, S15, and S17) and chemical flows output from the group SSC0 (e.g., S16 and S18) are deemed to be known.

FIG. 6G also illustrates that the output S21 of the node MX03 converges and the output S24 of the node MX04 converges. As a result, chemical flows within the group SSC1 (e.g., S19, S20, S21, S22, S23, S24, S25, and S27) and chemical flows output from the group SSC1 (e.g., S26 and S28) are deemed to be known.

FIG. 6G also illustrates that the group SSC2 of strongly connected components is ready for simulation, because all inputs (e.g., S18 and S07) to the group SSC2 are known.

FIG. 6G further illustrates that the node OT0 is ready for determination, because all input to the node OT0 (e.g., S16) is known. Similarly, the node OT4 is ready for determination, because all input to the node OT4 (e.g., S26) is known. Similarly, the node OT5 is ready for determination, because all input to the node OT5 (e.g., S28) is known.

In FIG. 6G, the node FT07 is identified as an initial component for simulation in the group SSC2. The node SPO4, which receives an input only from a 0-th order component (e.g., FT07), is identified as a first order component in the processing sequence index. The node MX05, which receives an input from a first order component (e.g., SP04) in addition to inputs from outside the group SSC2 (e.g., inputs S18 and S07), is identified as a second order component.

In FIG. 6H, the node FT07 is highlighted to indicate that the node FT07 is simulated. For example, the node FT07 is simulated using an estimated input S30. The outputs S31 and S33 of the node FT07 are determined from the simulation. The output S31 is used for processing a subsequent component in the group SSC2. The output S33 is typically not used for processing a subsequent component (e.g., OT2) until its convergence is checked.

In FIG. 6I, the node SP04 is highlighted to indicate that the node SP04 is simulated. The outputs S29 and S32 of the node SP04 are determined from the simulation. The output S29 is used for processing a subsequent component in the group SSC2. The output S32 is typically not used for processing a subsequent component (e.g., OT1) until its convergence is checked.

In FIG. 6J, the node MX05 is highlighted to indicate that the node MX05 is simulated. The output S30 of the node MX05 is determined from the simulation.

After the node MX05 is simulated, it is determined whether the output S30 of the node MX05 converges. For example, it is determined whether the output S30 of the node MX05 matches the estimated S30 (used for simulating FT07). If the output S30 of the node MX05 does not converge, simulation of the nodes in the group SSC2 is repeated.

FIG. 6K illustrates that the output S30 of the node MX05 converges. Thus, chemical flows within the group SSC2 (e.g., S29, S30, and S31) and chemical flows output from the group SSC2 (e.g., S32 and S33) are deemed to be known.

FIG. 6K also illustrates that the node OT1 is ready for determination, because all input to the node OT1 (e.g., S32) is known. Similarly, the node OT2 is ready for determination, because all input to the node OT2 (e.g., S33) is known.

FIG. 6L illustrates that all chemical flows in the graph are determined.

FIGS. 6A-6L described above illustrate determining chemical flows for a chemical process flowsheet using synchronous processing. FIGS. 6M-6Q illustrate determining chemical flows for strongly connected components in a chemical process flowsheet using asynchronous processing.

FIG. 6M illustrates the group SSC1 of strongly connected components. In FIG. 6M, each of the nodes and the edges in the group SSC1 has an iteration number. FIG. 6M also illustrates that the iteration number is negative one for all of the nodes and the edges except for initialized chemical flows (e.g., S21 and S24) and nodes receiving the initialized chemical flows (e.g., FT05 and FT06).

In FIG. 6N, simulation of the node FT05 is completed, and the outputs S22 and S25 of the node FT05 are determined. The node SP02 is given a new iteration number (e.g., 0), and simulation of the node SP02 is initiated prior to completing simulation of the node FT06.

In FIG. 6O, simulation of the node FT06 is completed, and the outputs S20 and S27 of the node FT06 are determined. The node SP03 is given a new iteration number (e.g., 0), and simulation of the node SP03 is initiated prior to completing simulation of the node SP02. FIG. 6O illustrates that the node MX03 is not given a new iteration number at this stage, because not all inputs to the node MX03 are known (e.g., S19 is not determined at this stage).

In FIG. 6P, simulation of the nodes SP02 and SP03 is completed, and the output S19 of the node SP02 and the output S23 of the node SP03 are determined. The nodes MX03 and MX04 are given a new iteration number (e.g., 0), and simulation of the nodes MX03 and MX04 is initiated.

After the simulation of the nodes MX03 and MX04 is completed, the output S21 of the node MX03 and the output S24 of the node MX04 are given a new iteration number (e.g., 1). In addition, the output S21 of the node MX03 and the output S24 of the node MX04 are checked for convergence. For example, the output S21 of the node MX03 at the iteration number 0 and the output S21 of the node MX03 at the iteration number 1 are compared. In accordance with a determination that the output S21 of the node MX03 at the iteration number 0 and the output S21 of the node MX03 at the iteration number 1 match (or satisfy convergence criteria, such as the output S21 of the node MX03 at the iteration number 1 differs from the output S21 of the node MX03 at the iteration number 0 by less than a predefined convergence threshold), the output S21 of the node MX03 is deemed to be converged.

In accordance with a determination that any of the output S21 of the node MX03 and the output S24 of the node MX04 does not converge, the simulation of the group SSC1 is repeated (e.g., the operations illustrated in FIGS. 6M-6Q except that the iteration number is increased in each subsequent iteration). For example, the nodes FT05 and FT06 are given a new iteration number (e.g., 1), and simulation of the nodes FT05 and FT06 is initiated. For brevity, these details are not repeated herein.

FIG. 7 is a flowchart illustrating operations performed by the distributed computing system 100 (FIG. 2) including the grid server 102, the node system 124, and the client system 122 in accordance with some embodiments.

In some embodiments, the client system 122 receives a user input (e.g., a keyboard input or a mouse click) that corresponds to a request for a simulation result (e.g., a request to perform a simulation and provide a result). The client system 122 sends (702) a request for a simulation result. In some embodiments, the client system 122 and/or the grid server 102 analyzes a chemical process flowsheet and identifies one or more chemical process components that are ready for simulation at a particular stage of the simulation.

The grid server 102 receives (704) the request. In some embodiments, the request includes a chemical process model (e.g., a chemical process flowsheet), and the grid server 102 processes the chemical process model (e.g., identifying computation tasks that can be performed concurrently). In some embodiments, the request includes only a portion of the chemical process model (the computation tasks that can be performed concurrently have been identified by the client system 122). The grid server 102 is coupled with multiple node systems 124, and the grid server 102 allocates (706) the computation tasks to the multiple node systems 124. In some embodiments, allocating the computation tasks includes determining which node systems 124 should receive one or more of the computation tasks. In some embodiments, a determination of which node systems should receive one or more of the computation tasks is made based on which node systems are idle, which node systems have low computing load, and/or conditions of network connections to the node systems. In some embodiments, the grid server 102 allocates no more than one task to a single node system 124. In some embodiments, allocating the computation tasks includes sending the computation tasks to respective node systems 124. For example, a first node system 124-1 in FIG. 2 receives a first task (e.g., determine chemical process flows for a first group of strongly connected components) and a second node system 124-M in FIG. 2 receives a second task (e.g., determine chemical process flows for a second group of strongly connected components).

In some embodiments, the grid server 102 is configured simply to distribute requests from the client system 122 to the node systems 124 and return results from the node systems 124 to the client system 122. Once the client system 122 receives simulation results from the grid server 102, the client system 122 sends subsequent requests to the grid server 102.

A node system 124 receives (708) an allocated task and processes (710) the received task (e.g., performs the allocated computation task). In some embodiments, the node system 124 processes the received task using (712) one or more virtual machines.

In some embodiments, the node system 124 further divides the allocated task into multiple sub-tasks. In some embodiments, the node system processes the multiple sub-tasks using respective virtual machines (e.g., processing a first sub-task using a first virtual machine, processing a second sub-task using a second virtual machine, etc.).

The node system 124 sends (714) a result of processing the received task (e.g., parameters of the chemical process flows, such as flow rate, temperature, chemical composition, etc.).

The grid server 102 receives and compiles (716) the result from each grid node system 124. For example, the grid server 102 receives a first result from the first grid node system 124-1 and a second result from the second grid node system 124-M.

In some embodiments, the grid server 102 allocates (706) a next set of computation tasks and receives results for the next set of computation tasks. In some embodiments, the grid server 102 repeats allocating computation tasks and receiving and compiling results until all computation tasks have been processed.

The grid server 102 sends (718) the compiled result to the client system 122.

The client system 122 receives (720) the compiled result. In some embodiments, the client system stores and/or displays (722) the compiled result (e.g., on the user interface 405, FIG. 4).

Thus, FIG. 7 illustrates determining chemical process flows for a chemical process flowsheet using the distributed computing system 100 (FIG. 2).

FIGS. 8A-8C are flowcharts illustrating a method 800 of determining chemical process flows for a chemical process flowsheet in accordance with some embodiments. The method 800 is performed at a computer system (e.g., the distributed computer system 100, FIG. 2 or a single computer server system) with one or more processors and memory. In some embodiments, each of the operations shown in FIGS. 8A-8C corresponds to instructions stored in a computer memory or non-transitory computer readable storage medium (e.g., memory 206 of the grid server 102 in FIG. 3 and/or memory 306 of the node system 124-1 in FIG. 4). The computer readable storage medium optionally includes a magnetic or optical disk storage device, solid state storage devices such as flash memory, or other non-volatile memory device or devices. The computer readable instructions stored on the computer readable storage medium optionally include one or more of: source code, assembly language code, object code, or other instruction format that is interpreted by one or more processors. Some operations in the method 800 are, optionally, combined and/or the order of some operations is, optionally, changed.

The computer system identifies (802) a plurality of computation units for a chemical process flowsheet (e.g., the chemical process flowsheet shown in FIG. 1) represented by a graph (e.g., the graph shown in FIG. 6A) with a plurality of components. The plurality of components includes at least one group of strongly connected components (e.g., SSC0, SSC1, and SSC2 in FIG. 6A). Each computation unit of the plurality of computation units is either a single component (e.g., the node FT00) or a group of strongly connected components of the plurality of components (e.g., the group SSC2 including nodes MX05, FT07, and SP04).

The computer system identifies (804) two or more non-overlapping computation units of the plurality of computation units (e.g., the group SSC0 and the group SSC1). The two or more non-overlapping computation units do not include a same component (e.g., the group SSC0 and the group SSC1 do not have a common component). In some embodiments, a first computation unit is distinct from a second computation unit and the first computation unit does not include a component that is included in the second computation unit. In some embodiments, the second computation unit does not include a component that is included in the first computation unit.

All chemical inputs to the two or more non-overlapping computation units have been determined. For example, FIG. 6C illustrates that all inputs to the groups SSC0 and SSC1 are determined. In some embodiments, all chemical inputs to the two or more computation units are known prior to processing the two or more computation units at least partially in parallel.

The computer system processes (806) the two or more non-overlapping computation units at least partially in parallel by processing each computation unit of the two or more non-overlapping computation units using a separate set of one or more processors. For example, the group SSC0 is processed by the node system 124-1 (FIG. 1) and the group SSC1 is processed by the node system 124-M (FIG. 1). In another example, the group SSC0 is processed by a first processor or a first core of the grid server 102 (FIG. 1) and the group SSC1 is processed by a second processor or a second core of the grid server 102. Thus, in some embodiments, the two or more non-overlapping computational units are processed simultaneously at least at one or more instances.

In some embodiments, processing a computation unit includes (808) determining one or more chemical outputs of the computation unit. For example, processing the node FT00 (FIG. 6C) includes determining parameters of the chemical outputs S02 and S03 of the node FT00 (e.g., a temperature, a pressure, a flow rate, concentrations of chemical species in each output flow, etc.). In some embodiments, the one or more chemical outputs of the computation unit are calculated in accordance with predefined simulation criteria (e.g., mass balance, energy balance, equipment size criteria, cost criteria, etc.).

In some embodiments, the separate set of one or more processors is (810) a set of one or more virtual processors. In some embodiments, the one or more virtual processors corresponds to a single physical processor or core configured to operate as multiple virtual processors (e.g., using a virtual machine). In some embodiments, the virtual processors correspond to physical processors or cores that are fewer in number than the virtual processors (e.g., ten virtual processors may correspond to five physical processors or cores). In some embodiments, the one or more processors are physically separate processors or cores. In some embodiments, the one or more processors are physically located remotely from one another. For example, a first processor may be included in a first server computer and a second processor may be included in a second server computer physically located separately and remotely from the first server computer (e.g., as in grid computing or distributed computing).

In some embodiments, the computer system identifies (812, FIG. 8B) one or more non-overlapping computation units of the plurality of computation units (e.g., the node FT02, FIG. 6D). In some embodiments, the computer system processes a single computation unit and in some embodiments, the computer system processes two or more computation units in parallel. All chemical inputs to each computation unit of the one or more non-overlapping computation units have been determined (e.g., the chemical flow S06, FIG. 6D). The computer system determines whether the one or more non-overlapping computation units include only one computation unit. In accordance with a determination that the one or more non-overlapping computation units include only one computation unit, the computer system processes the only one computation unit using a single set of one or more processors. In accordance with a determination that the one or more non-overlapping computation units include two or more computation units whose chemical inputs are all known (e.g., the groups SSC0 and SSC1), the computer system processes each computation unit of the two or more computation units separately and at least partially in parallel using a separate set of one or more processors.

In some embodiments, the computer system processes a single component. For example, when only a single component is ready for simulation at a particular stage of simulating the chemical process flowsheet, the computer system processes only a single component (e.g., a single mixer).

In some embodiments, processing a computation unit that is a group of strongly connected components of the plurality of components includes (814) generating a processing sequence list of strongly connected components in the group by identifying, as one or more initial components for processing, one or more components of the strongly connected components in the group and assigning a processing sequence index that corresponds to the one or more initial components for processing and identifying one or more N generation components and assigning a processing sequence index that corresponds to the one or more N generation components. For example, FIG. 6C illustrates that the nodes FT03 and FT04 are identified as initial components for simulation of the group SSC0 and each of the nodes in the group SSC0 of strongly connected components has a processing sequence index. The methods for identifying initial components for processing a group of strongly connected components are known (e.g., tearing). For brevity, these details are not repeated herein.

In some embodiments, all chemical inputs to the one or more N generation components are known subsequent to determining chemical outputs of all N-1 generation components. For example, all inputs S15 and S17 to the first order nodes SP00 and SP01 are known subsequent to determining the chemical outputs of the 0-th order nodes FT03 and FT04. Generating the processing sequence list of strongly connected components in the group includes repeating, for one or more subsequent generations, the identifying one or more N generation components and assigning a processing sequence index that corresponds to the one or more N generation components, where all chemical inputs to the one or more N generation components are known subsequent to calculating chemical outputs of all N-1 generation components. Each time the identifying and assigning are repeated, N is advanced by a generation (e.g., after identifying first order nodes based on the outputs of 0-th order nodes, second order nodes are identified based on the outputs of the first order nodes). Processing the computation unit that is a group of strongly connected components also includes sequentially processing the strongly connected components in the group in accordance with the processing sequence list, including concurrently processing strongly connected components that have a same processing sequence index. For example, in FIGS. 6D-6F, nodes FT03 and FT04 are concurrently processed, and subsequent to processing the nodes FT03 and FT04, the nodes SP00 and SP01 are concurrently processed.

In some embodiments, processing a computation unit that is a group of strongly connected components of the plurality of components includes (816, FIG. 8C) identifying one or more components of the strongly connected components in the group. Each of the one or more components has either only one chemical input, the only one chemical input having been calculated, or multiple chemical inputs, the multiple chemical inputs having a same iteration sequence. For example, the node SP02 in FIG. 6N has only one input S25 that has been calculated (e.g., indicated with the iteration number 0), and the node SP02 is ready for simulation. In another example, the node MX03 in FIG. 6P has two inputs S19 and S20, both of which have the same iteration number 0, and the node MX03 is ready for simulation. In comparison, the inputs S19 and S20 of the node MX03 in FIG. 6O have different iteration numbers, and the node MX03 in FIG. 6O is not ready for simulation.

In some embodiments, processing the computation unit that is a group of strongly connected components also includes processing the one or more identified components of the strongly connected components in the group and assigning a corresponding iteration sequence to one or more outputs of the one or more identified components of the strongly connected components in the group (e.g., after processing the node FT05 that has the iteration number 0 in FIG. 6M, the outputs S25 and S22 of the node FT05 are given the same iteration number 0 in FIG. 6N); and repeating the identifying one or more components of the strongly connected components in the group, processing the one or more identified components of the strongly connected components in the group, and assigning a corresponding iteration sequence to one or more outputs of the one or more identified components of the strongly connected components in the group.

In some embodiments, the one or more identified components include (818) two or more identified components. The repeating includes determining that at least one identified component of the two or more identified components has been processed; and, in response to determining that at least one identified component of the two or more identified components has been processed, initiating the identifying step before the two or more identified components, other than the at least one identified component, have been processed. For example, in accordance with a determining that the node FT06 is processed in FIG. 6O, the node SP03 is identified as being ready for simulation while simulation of the node SP02 is not complete.

In some embodiments, the computer system determines (820) whether the strongly connected components in the group satisfy predefined convergence criteria; and, in accordance with a determination that the strongly connected components in the group do not satisfy the predefined convergence criteria, repeats the sequentially processing the strongly connected components in the group in accordance with the sequence list and determining whether the strongly connected components in the group satisfy the predefined convergence criteria. For example, parameters (e.g., flow rate, temperature, chemical composition, etc.) of a chemical flow determined from a previous iteration and a current iteration are compared. In some embodiments, the chemical flow is deemed to satisfy the predefined convergence criteria in accordance with a determination that the parameters of the chemical flow determined from the previous iteration differ from the parameters of the chemical flow determined from the current iteration by less than a predefined amount (e.g., a predefined fraction or percentage).

In some embodiments, the method includes, in accordance with a determination that the strongly connected components in the group satisfy the predefined convergence criteria, storing chemical outputs from the strongly connected components (e.g., in the result database 118, FIG. 2). In some embodiments, the method includes, in accordance with the determination that the strongly connected components in the group satisfy the predefined convergence criteria, processing a subsequent group of strongly connected components. For example, FIG. 6G illustrates that in accordance with a determination that the strongly connected components in the group SSC0 satisfy the predefined convergence criteria, the group SSC2 of strongly connected components is processed.

The computer system determines (822, FIG. 8A) process flows for the chemical process flowsheet. For example, by compiling the results from separate node systems (e.g., operation 716, FIG. 7), the entire process flows for the chemical process flowsheet are determined.

In some embodiments, the computer system outputs the process flows. In some embodiments, the computer system displays the process flows (e.g., a display device). In some embodiments, the computer system transfers the process flows to another computer system for display. In some embodiments, the computer system stores the process flows. In some embodiments, the computer system initiates chemical process flows in accordance with the determined process flows for the chemical process flowsheet.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the underlying principles and their practical applications, to thereby enable others skilled in the art to best utilize the described principles and various embodiments with various modifications as are suited to the particular use contemplated.

For example, in some embodiments, a computer system with multiple processors and memory identifies a plurality of computation units for a chemical process flowsheet represented by a graph with a plurality of components. Each computation unit of the plurality of computation units is either a single component or a group of strongly connected components of the plurality of components. However, the plurality of computation units need not include one or more group of strongly connected components (i.e., the plurality of computation units may not include any group of strongly connected components). The computer system identifies two or more non-overlapping computation units of the plurality of computation units. All chemical inputs to the two or more non-overlapping computation units have been determined. The computer system processes the two or more non-overlapping computation units at least partially in parallel by processing each computation unit of the two or more non-overlapping computation units using a separate set of one or more processors, and determines process flows for the chemical process flowsheet.

The terminology used in the description of the embodiments herein is for the purpose of describing particular embodiments only and is not intended to be limiting of the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification and claims, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first node system could be termed a second node system, and, similarly, a second node system could be termed a first node system, without departing from the underlying principles. The first node system and the second node system are both node systems, but they are not the same node system.

What is claimed is:

1. A method, comprising:
at a computer system with multiple processors and memory:
identifying a plurality of computation units for a chemical process flowsheet represented by a graph with a plurality of components, the plurality of components including at least one group of strongly connected components, each computation unit of the plurality of computation units being either a single component or a group of strongly connected components of the plurality of components;
identifying two or more non-overlapping computation units of the plurality of computation units, wherein all chemical inputs to the two or more non-overlapping computation units have been determined;
processing the two or more non-overlapping computation units at least partially in parallel by processing each computation unit of the two or more non-overlapping computation units using a separate set of one or more processors; and
determining process flows for the chemical process flowsheet.

2. The method of claim 1, including:
identifying one or more non-overlapping computation units of the plurality of computation units, wherein all chemical inputs to each computation unit of the one or more non-overlapping computation units have been determined;
determining whether the one or more non-overlapping computation units include only one computation unit;
in accordance with a determination that the one or more non-overlapping computation units include only one computation unit, processing the only one computation unit using a single set of one or more processors; and,
in accordance with a determination that the one or more non-overlapping computation units include two or more computation units whose chemical inputs are all known, processing each computation unit of the two or more computation units separately and at least partially in parallel using a separate set of one or more processors.

3. The method of claim 1, wherein:
processing a computation unit that is a group of strongly connected components of the plurality of components includes:
generating a processing sequence list of strongly connected components in the group by:
identifying, as one or more initial components for processing, one or more components of the strongly connected components in the group and assigning a processing sequence index that corresponds to the one or more initial components for processing;
identifying one or more N generation components and assigning a processing sequence index that corresponds to the one or more N generation components, wherein all chemical inputs to the one or more N generation components are known subsequent to determining chemical outputs of all N-1 generation components; and
repeating, for one or more subsequent generations, the identifying one or more N generation components and assigning a processing sequence index that corresponds to the one or more N generation components, wherein:
all chemical inputs to the one or more N generation components are known subsequent to calculating chemical outputs of all N-1 generation components; and
each time the identifying and assigning are repeated, N is advanced by a generation; and
sequentially processing the strongly connected components in the group in accordance with the processing sequence list, including concurrently processing strongly connected components that have a same processing sequence index.

4. The method of claim 1, wherein:
processing a computation unit that is a group of strongly connected components of the plurality of components includes:
identifying one or more components of the strongly connected components in the group, wherein each of the one or more components has:
only one chemical input, the only one chemical input having been calculated, or
multiple chemical inputs, the multiple chemical inputs having a same iteration sequence;
processing the one or more identified components of the strongly connected components in the group and assigning a corresponding iteration sequence to one or more outputs of the one or more identified components of the strongly connected components in the group; and
repeating the identifying one or more components of the strongly connected components in the group, processing the one or more identified components of the strongly connected components in the group, and assigning a corresponding iteration sequence to one or more outputs of the one or more identified components of the strongly connected components in the group.

5. The method of claim 4, wherein:
the one or more identified components include two or more identified components;
the repeating includes:
determining that at least one identified component of the two or more identified components has been processed; and,
in response to determining that at least one identified component of the two or more identified components has been processed, initiating the identifying step before the two or more identified components, other than the at least one identified component, have been processed.

6. The method of claim 3, including:
determining whether the strongly connected components in the group satisfy predefined convergence criteria; and,
in accordance with a determination that the strongly connected components in the group do not satisfy the predefined convergence criteria, repeating the sequentially processing the strongly connected components in the group in accordance with the sequence list and determining whether the strongly connected components in the group satisfy the predefined convergence criteria.

7. The method of claim 1, wherein processing a computation unit includes determining one or more chemical outputs of the computation unit.

8. The method of claim 1, wherein the separate set of one or more processors is a set of one or more virtual processors.

9. A computer system, comprising:
multiple processors; and
memory storing one or more programs for execution by the multiple processors, the one or more programs including instructions for:
identifying a plurality of computation units for a chemical process flowsheet represented by a graph with a plurality of components, the plurality of components including at least one group of strongly connected components, each computation unit of the plurality of computation units being either a single component or a group of strongly connected components of the plurality of components;
identifying two or more non-overlapping computation units of the plurality of computation units, wherein all chemical inputs to the two or more non-overlapping computation units have been determined;
processing the two or more non-overlapping computation units at least partially in parallel by processing each computation unit of the two or more non-overlapping computation units using a separate set of one or more processors; and
determining process flows for the chemical process flowsheet.

10. The system of claim 9, wherein the one or more programs include instructions for:
identifying one or more non-overlapping computation units of the plurality of computation units, wherein all chemical inputs to each computation unit of the one or more non-overlapping computation units have been determined;
determining whether the one or more non-overlapping computation units include only one computation unit;
in accordance with a determination that the one or more non-overlapping computation units include only one computation unit, processing the only one computation unit using a single set of one or more processors; and,
in accordance with a determination that the one or more non-overlapping computation units include two or more computation units whose chemical inputs are all known, processing each computation unit of the two or more computation units separately and at least partially in parallel using a separate set of one or more processors.

11. The system of claim 9, wherein:
processing a computation unit that is a group of strongly connected components of the plurality of components includes:
generating a processing sequence list of strongly connected components in the group by:
identifying, as one or more initial components for processing, one or more components of the strongly connected components in the group and assigning a processing sequence index that corresponds to the one or more initial components for processing;
identifying one or more N generation components and assigning a processing sequence index that corresponds to the one or more N generation components, wherein all chemical inputs to the one or more N generation components are known subsequent to determining chemical outputs of all N-1 generation components; and
repeating, for one or more subsequent generations, the identifying one or more N generation components and assigning a processing sequence index that corresponds to the one or more N generation components, wherein:
all chemical inputs to the one or more N generation components are known subsequent to calculating chemical outputs of all N-1 generation components; and
each time the identifying and assigning are repeated, N is advanced by a generation; and
sequentially processing the strongly connected components in the group in accordance with the processing sequence list, including concurrently processing strongly connected components that have a same processing sequence index.

12. The system of claim 9, wherein:
processing a computation unit that is a group of strongly connected components of the plurality of components includes:
identifying one or more components of the strongly connected components in the group, wherein each of the one or more components has:
only one chemical input, the only one chemical input having been calculated, or
multiple chemical inputs, the multiple chemical inputs having a same iteration sequence;
processing the one or more identified components of the strongly connected components in the group and assigning a corresponding iteration sequence to one or more outputs of the one or more identified components of the strongly connected components in the group; and
repeating the identifying one or more components of the strongly connected components in the group, processing the one or more identified components of the strongly connected components in the group, and assigning a corresponding iteration sequence to one or more outputs of the one or more identified components of the strongly connected components in the group.

13. The system of claim 12, wherein:
the one or more identified components include two or more identified components;
the repeating includes:
determining that at least one identified component of the two or more identified components has been processed; and,
in response to determining that at least one identified component of the two or more identified components has been processed, initiating the identifying step before the two or more identified components, other than the at least one identified component, have been processed.

14. The system of claim 11, wherein the one or more programs include instructions for:
determining whether the strongly connected components in the group satisfy predefined convergence criteria; and,
in accordance with a determination that the strongly connected components in the group do not satisfy the predefined convergence criteria, repeating the sequentially processing the strongly connected components in the group in accordance with the sequence list and determining whether the strongly connected components in the group satisfy the predefined convergence criteria.

15. A computer readable storage medium storing one or more programs for execution by multiple processors of a computer system, the one or more programs including instructions for:
identifying a plurality of computation units for a chemical process flowsheet represented by a graph with a plurality of components, the plurality of components including at least one group of strongly connected components, each computation unit of the plurality of computation units being either a single component or a group of strongly connected components of the plurality of components;
identifying two or more non-overlapping computation units of the plurality of computation units, wherein all chemical inputs to the two or more non-overlapping computation units have been determined;
processing the two or more non-overlapping computation units at least partially in parallel by processing each computation unit of the two or more non-overlapping computation units using a separate set of one or more processors; and
determining process flows for the chemical process flowsheet.

16. The computer readable storage medium of claim 15, wherein the one or more programs include instructions for:
identifying one or more non-overlapping computation units of the plurality of computation units, wherein all chemical inputs to each computation unit of the one or more non-overlapping computation units have been determined;
determining whether the one or more non-overlapping computation units include only one computation unit;
in accordance with a determination that the one or more non-overlapping computation units include only one computation unit, processing the only one computation unit using a single set of one or more processors; and,
in accordance with a determination that the one or more non-overlapping computation units include two or more computation units whose chemical inputs are all known, processing each computation unit of the two or more computation units separately and at least partially in parallel using a separate set of one or more processors.

17. The computer readable storage medium of claim 15, wherein:
processing a computation unit that is a group of strongly connected components of the plurality of components includes:
generating a processing sequence list of strongly connected components in the group by:
identifying, as one or more initial components for processing, one or more components of the strongly connected components in the group and assigning a processing sequence index that corresponds to the one or more initial components for processing;
identifying one or more N generation components and assigning a processing sequence index that corresponds to the one or more N generation components, wherein all chemical inputs to the one or more N generation components are known subsequent to determining chemical outputs of all N-1 generation components; and
repeating, for one or more subsequent generations, the identifying one or more N generation components and assigning a processing sequence index that corresponds to the one or more N generation components, wherein:
all chemical inputs to the one or more N generation components are known subsequent to calculating chemical outputs of all N-1 generation components; and
each time the identifying and assigning are repeated, N is advanced by a generation; and
sequentially processing the strongly connected components in the group in accordance with the processing sequence list, including concurrently processing strongly connected components that have a same processing sequence index.

18. The computer readable storage medium of claim 15, wherein:
processing a computation unit that is a group of strongly connected components of the plurality of components includes:
identifying one or more components of the strongly connected components in the group, wherein each of the one or more components has:
only one chemical input, the only one chemical input having been calculated, or
multiple chemical inputs, the multiple chemical inputs having a same iteration sequence;
processing the one or more identified components of the strongly connected components in the group and assigning a corresponding iteration sequence to one or more outputs of the one or more identified components of the strongly connected components in the group; and
repeating the identifying one or more components of the strongly connected components in the group, processing the one or more identified components of the strongly connected components in the group, and assigning a corresponding iteration sequence to one or more outputs of the one or more identified components of the strongly connected components in the group.

19. The computer readable storage medium of claim 18, wherein:
the one or more identified components include two or more identified components;
the repeating includes:
determining that at least one identified component of the two or more identified components has been processed; and,
in response to determining that at least one identified component of the two or more identified components has been processed, initiating the identifying step before the two or more identified components, other than the at least one identified component, have been processed.

20. The computer readable storage medium of claim 17, wherein the one or more programs include instructions for:
determining whether the strongly connected components in the group satisfy predefined convergence criteria; and,
in accordance with a determination that the strongly connected components in the group do not satisfy the predefined convergence criteria, repeating the sequentially processing the strongly connected components in the group in accordance with the sequence list and determining whether the strongly connected components in the group satisfy the predefined convergence criteria.
